(19) United States
(12) Patent Application Publication
(10) Pub. No.: US 2026/0316258 A1
(43) Pub. Date: Oct. 15, 2026

(54) EXOSKELETON AND SMART CRUTCH SYSTEMS

(71) Applicant: LIFEWARD LTD., Yokneam (IL)

(72) Inventors: David HEXNER, Katzir (IL); Yehuda BITTON, Haifa (IL)

(73) Assignee: LIFEWARD LTD., Yokneam (IL)

(21) Appl. No.: 19/689,035

(22) Filed: May 27, 2026

Related U.S. Application Data
(63) Continuation of application No. PCT/US2024/057912, filed on Nov. 27, 2024.
(60) Provisional application No. 63/603,086, filed on Nov. 27, 2023.
(60) Provisional application No. 63/564,885, filed on Mar. 13, 2024.

(51) Int. Cl. B25J 9/00; A61H 3/00; A61H 3/02

(52) U.S. Cl. CPC B25J 9/0006; A61H 3/02; A61H 2003/007; A61H 2201/0192; A61H 2201/5069

(57) ABSTRACT

An exoskeleton-based method for determining an estimated slope of a ground surface upon which the exoskeleton is being used. The exoskeleton includes a height, a central axis corresponding to the height, and an associated crutch with a crutch axis. The method includes: providing first data corresponding to a level crutch angle, defined as the angle the crutch axis forms with the central axis when the exoskeleton is in a standing or walking position on a flat, level surface; providing a database of crutch angles each corresponding to a specific ground surface slope; determining a current crutch angle corresponding to the current angle the crutch axis forms with the central axis while the exoskeleton is in use on a current ground surface; comparing the current crutch angle to the database of crutch angles; and determining the estimated slope of the current ground surface.

### CROSS REFERENCE TO RELATED APPLICATIONS

This application is a continuation of PCT International Patent Application No. PCT/US 2024/057912, international filing date Nov. 27, 2024, which claims the benefit of U.S. Provisional Patent Application No. 63/564,885, filed Mar. 13, 2024, and U.S. Provisional Patent Application No. 63/603,086, filed Nov. 27, 2023, each of which is hereby incorporated by reference in its entirety.

### FIELD OF THE INVENTION

The subject disclosure is directed to exoskeleton devices and systems, and in particular, devices and systems for operating and controlling an exoskeleton in view of use thereof including initiating and changing operation based on, inter alia, any of surface and/or surface slope detection, context recognition (such as obstacles) gesture recognitions, and autonomous curb/stair climb.

### BACKGROUND OF THE INVENTION

Rehabilitation devices for quadriplegics are confined to wheelchairs as well as available devices in rehabilitation institutions that are used for training purpose. Exoskeleton (ES) and RGO (Reciprocating Gait Orthosis) based devices require crutches or walking frames (walkers) in order to enable/restore up-right mobility to people with mobility impairment such as paraplegics. But a significant number of people with mobility impairment are not able to hold or support themselves by commercial crutches or walkers (e.g., quadriplegics).

It is therefore an object of embodiments of the present disclosure to provide improved assistance devices and functionality for those who use exoskeletons or other devices which help those with spinal cord injuries use and control the same.

### SUMMARY OF THE INVENTION

Embodiments of the present disclosure are directed to several inventions and corresponding embodiments thereof, which include, context awareness, surface type classification, stabilization and fall avoidance, perception, gait adaptation to context, and intent/gesture recognition. Any and all of the noted structure, sensors, image and video capturing instruments (such as a camera), inertial measurement or mapping unit(s) (IMU), processor, and communication means, can be arranged on the exoskeleton and/or a crutch and/or on a crutch(es). Details for at least some of these is noted below provided figures.

In some embodiments, an exoskeleton user-interface comprising context awareness means for controlling one or more aspects of the use and control of the exoskeleton. Such embodiments (as well as other embodiments disclosed herein) may additionally including one and/or another of the following functions, functionality, structure, step, and/or clarifications (and if not mutually exclusive, in some embodiments a plurality of, and in some embodiments, a majority of, and in some embodiments, substantially all of, and in some embodiments, all of):
context awareness comprises one or more of surface type classification, stabilization and/or fall avoidance, perception, gait adaptation, and intent/gesture recognition;
context awareness comprises at least one of the following components: one or more sensors, an IMU, a processor, and communication means;
context awareness comprises at least a plurality of the following components: one or more sensors, an IMU, a processor, and communication means;
the context awareness comprises at least a majority of the following components: one or more sensors, an IMU, a processor, and communication means;
context awareness comprises at least substantially all of the following components: one or more sensors, an IMU, a processor, and communication means;
context awareness comprises at least all of the following components: one or more sensors, an IMU, a processor, and communication means;
context awareness comprises any and all of the following components: one or more sensors, an IMU, a processor, and communication means;
the user-interface is positioned on at least one crutch;
at least one component is included on a first crutch and at least one component is included on a second crutch;
at least two components are included on a first crutch and at least one component is included on a second crutch;
at least two components are included on a first crutch and at least two components are included on a second crutch;
the user-interface comprises augmented reality eyewear, and wherein at least one of the exoskeleton, a crutch, and the eyewear include at least one camera collecting at least one of still and video;
a/the eyewear is configured to display exoskeleton modes and/or detection of objects imaged by the at least one camera;
a/the at least one camera comprises a stereoscopic and/or RGB and/or IR camera;
an image and/or video and/or context detection engine, configured with machine learning so as to be configured for detection and classification of data collected including any and all of images, radar reflections, LED light reflection for objects and/or surfaces surrounding at least a portion of the area surrounding the exoskeleton;
a radar, or wherein the radar, may comprise a millimetric radar;
one or more additional sensors which include any and all of an ultrasonic sensor and an infrared sensor; and
the user interface comprises a crutch with mounted buttons and/or mounted display.

In some embodiments, a system, apparatus, device or method is provided, associated with an exoskeleton, which includes detection means configured to detect an object at least within a path of the exoskeleton during use.

Such embodiments (as well as other embodiments disclosed herein) may additionally including one and/or another of the following functions, functionality, structure, step, and/or clarifications (and if not mutually exclusive, in some embodiments a plurality of, and in some embodiments, a majority of, and in some embodiments, substantially all of, and in some embodiments, all of):
alert means configured to alert the user of the exoskeleton upon the object being within a direction of travel of the exoskeleton;
alert means which may comprise any and all of an audible alert including any and all of a tone and recorded or generated spoken alert, a visual alert which can comprise a light or an image displayed in view of the user of the exoskeleton;
and any of the functions, functionality, structure, step, and/or clarifications noted above.

In some embodiments, an exoskeleton apparatus is provided an may include an infrared (IR) spectrometry analysis system configured to detect a ground or floor surface that the exoskeleton is to or interacts with, including those corresponding to any and all of indoor areas: carpeting, ceramics, and tile, and outdoor areas: grass, dirt, concrete, brick, stone, and asphalt.

Such embodiments (as well as other embodiments disclosed herein) may additionally including one and/or another of the following functions, functionality, structure, step, and/or clarifications (and if not mutually exclusive, in some embodiments a plurality of, and in some embodiments, a majority of, and in some embodiments, substantially all of, and in some embodiments, all of):
at least one corresponding crutch device for use therewith;
the IR system includes one or more and preferably, a plurality of light-emitting-diodes (LEDs) including at least one LED in the visible spectrum and at least one LED in the infrared spectrum;
a/the LEDs are configured to illuminate a surface upon which the exoskeleton is being used;
at least one photodiode arranged on a component/part of the exoskeleton, the at least one photodiode configured to measure at least one value of reflected LED from a surface;
a/the value measured is at least one wavelength;
a/the measured values are processed via a processor so as to classify a surface being detected and/or encountered by the apparatus;
a/the processor compares the received signals with a lookup table of known values corresponding to a plurality of surfaces;
processing by the processor utilizes artificial intelligence to determine the surface from the collected values;
upon detection of a predetermined surface, the apparatus changes any and all of forces and movements so as to conform thereof to the characteristics of the surface;—each surface type corresponds to a specific set of forces and/or movements by the exoskeleton;
a battery-operated electronic device mounted on a portion of the at least one crutch;
a/the electronic device comprises electronic circuitry configured to perform spectrum analysis using signals collected from one or more photodiodes;
an internal mapping unit (IMU);
the IMU includes at least one of an accelerometer and a gyroscope;
the IMU is configured to at least one of detect a walking pattern of the exoskeleton apparatus and/or any crutch encounters with a surface;
at least one camera;
a/the IR includes at least one camera;
image information provided by the at least one camera is analyzed via artificial intelligence (AI) either locally or remotely to determine surface that the exoskeleton surface is or will soon encounter;
upon determination of the surface, the apparatus is configured to operate according to predetermined forces and/or movements so as to perform any and all of standing, walking, stairs, objects, and sitting, so as to operate on such identified surface; an/the IMU determines a crutch orientation;
the crutch orientation corresponds to a surface slope angle;
the IMU includes at least one of an accelerometer and a gyroscope and may include a magnetometer;
a/the accelerometer and/or a/the gyroscope and/or magnetometer are configured to provide signals to a processor for the analysis of a walking pattern of the exoskeleton apparatus;
based center of mass calculations which are derived from output from the onboard—IMU and/or sensors and/or crutch mounted IMU and/or exoskeleton mounted encoders the exoskeleton is configured to adjust gait to accommodate a slope of a surface being encountered by the exoskeleton apparatus;
based on output from the onboard IMU and/or crutch mounted IMU, the exoskeleton detects and measures the slop angle and then is configured to adjust gait to accommodate a slope of a surface being encountered by the exoskeleton apparatus; and
a/the at least one camera configured to collect image data, and using analytical calculations and/or AI, detect and determine the slope angle that the user of the exoskeleton is or will be encountering, and provide the slope angle to a controller of the exoskeleton to then select the correct posture and/or forces, movements, and speed; at least one, and preferably a plurality, and preferably all, for the exoskeleton to follow.

In some embodiments, a crutch for an exoskeleton configured to detect and determine a user's will so as to enter a mode of movement of an exoskeleton, including any and all of sit, stand, walk, stairs, and object avoidance based optionally on at least crutch movement (“gesture”) by a user of the crutch is recognized by the exoskeleton (“gesture recognition”) or user input via an interface of the crutch or exoskeleton.

Such embodiments (as well as other embodiments disclosed herein) may additionally including one and/or another of the following functions, functionality, structure, step, and/or clarifications (and if not mutually exclusive, in some embodiments a plurality of, and in some embodiments, a majority of, and in some embodiments, substantially all of, and in some embodiments, all of):
upon the user of the exoskeleton approaching a stair or a curb, the user adjusts and/or moves the crutch in a predetermined manner such that the exoskeleton anticipates and will perform movement to climb up the stairs or curb;
movement of the crutch in a direction (e.g., forward) indicates to the exoskeleton a length required for alignment with a/the stair/curb; and
a plurality of gestures can be used each corresponding to one or more unique movements and associated velocity and/or forces of motors and/or joints of the exoskeleton.

In some embodiments, a system, apparatus, device or method according to any of the above-claimed embodiments, or other embodiments disclosed herein, further comprising LIDAR.

In some embodiments disclosed herein, information gathered by one or more sensors is analyzed via A to determine one or more characteristics of the environment surrounding at least a portion of the exoskeleton.

In some of the inventions and embodiments, a user interface is provided, and a device for context detection (which can be incorporated into the user interface). In some embodiments, a brain-machine-interface is used for user intent (which can be said interface).

Some of the inventions and embodiments can also use, for example: a wrist mounted controller for controlling an exoskeleton or any of the inventions and embodiments of the present disclosure, one or more tilt sensors, augmented reality (AR) glasses, smart crutches and use of other inertial sensors for detecting and specific body movements. The gait movements are performed by a set of gears and motors at different joints of the exoskeleton (e.g., knee and hip) in addition to a passive angle joint which can include a spring mechanism. Systems and devices according to the disclosed inventions and embodiments are preferably for use in indoor and outdoor settings and can include use for standing and walking on level surfaces and mild slopes and ascending and descending stairs and curbs.

The pair of augmented reality smart glasses can be used for a user interface which can be used for on screen display of exoskeleton modes, as well as detection of objects, particularly those which need special attention by a user of an exoskeleton such as stairs, curbs, and other obstacles etc.

In some inventions and embodiments, a stereoscopic camera can be included with an image and context detection engine (operable artificial intelligence or deterministic algorithms) for detection and classification of data collected (e.g., images, radar reflections, LED light reflection) for objects such as stairs, curbs, obstacles etc. which are in the path of an exoskeleton. Radar used in some embodiments, may be a millimetric radar. In some embodiments, additional sensors can be used (which, in some embodiments, can be used in place of a camera) including ultrasonic sensors and infrared sensors.

In some inventions and embodiments, detection of a meaningful object (e.g., a curb), systems and/or devices can be configured to alert the user and perform a certain action(s) autonomously (e.g., such as slow down and approach the curb according to a measured distance).

In some embodiments, an exoskeleton-based method for detecting a type of surface upon which the exoskeleton is being used is provided and include, using spectroscopy and/or imagery. With respect to spectroscopy, the method include emitting light from one or more LEDs arranged on at least one of one or more portions of an exoskeleton and one or more portions of a crutch, where the emitted light reflects of a surface proximate the exoskeleton; receiving the reflected light via one or more photodiodes arranged on at least one of one or more portions of the exoskeleton and one or more portions of the crutch, and comparing one or more wavelengths of the reflected light to known wavelength values of one or more surfaces types stored in a memory or accessible via a network to identify the surface type. With respect to using imagery, collecting image data of the surface via at least one camera arranged on the exoskeleton, the crutch(es), or other accessory, and comparing the collected image data to image data of one or more surface types stored in a memory or accessible via a network to identify the surface type.

Such embodiments (as well as other embodiments disclosed herein) may additionally including one and/or another of the following functions, functionality, structure, step, and/or clarifications (and if not mutually exclusive, in some embodiments a plurality of, and in some embodiments, a majority of, and in some embodiments, substantially all of, and in some embodiments, all of):
the surface comprises at least one of a ground surface and a vertical surface of a nearby structure;
the identified surface type is selected from the group consisting of carpeting, ceramics, tile, grass, dirt, concrete, brick, stone, asphalt, wet, snowy or icy and combinations of the foregoing;
data collected form at least one of a crutch(es) and exoskeleton using pretrained AI models;
collecting and/or comparting is performed by one or more processors provided for on at least one of the exoskeleton, the crutch(es), and a remote device;
a/the one or more processors comprise an internal mapping unit (IMU);
upon the surface being identified, the method further includes modifying the operation of the exoskeleton;
the operation of the exoskeleton is modified by changing a mode of the exoskeleton;
the mode is selected from the group considering of: walking, standing, sitting, collapsing, stopping, stair/curb climbing;
modifying the operation of the exoskeleton comprises any of (and in some embodiments, a plurality of, and in some embodiments, a majority of, and in some embodiments, substantially all of, and in some embodiments, all of:
   modifying the forces applied by one or more motors on one or more exoskeleton elements and/or components of such elements;
   modifying a speed of movement of the exoskeleton and/or one or more components of the exoskeleton and/or components of such elements;
   modifying a distance of movement of the exoskeleton and/or one or more components of the exoskeleton and/or components of such elements;
   modifying relative angular movement between two elements of the exoskeleton and/or components of such elements; and
   modifying a timing of movement of the exoskeleton and/or movement of one or more components of the exoskeleton and/or components of such elements;
collecting data from one or more sensors in additional to a spectrometry or image associated sensors;
one more additional sensors comprise at least one of an accelerometer and a gyroscope; and
modifying operation of the exoskeleton corresponds to increasing the stability of the exoskeleton.

In some embodiments, an exoskeleton based method for detecting an orientation of an exoskeleton relative to a ground surface, and/or an orientation of one or more accessories used with the exoskeleton is provided and includes determining a slope of a surface upon which an exoskeleton is being used via one or more sensors, where the orientation of the exoskeleton and/or one or more accessories used with the exoskeleton corresponds to the angle determined by the one or more sensors. In some embodiments, the one or more sensors comprise at least one of an accelerometer, a gyroscope and a level sensor.

In some embodiments of the present disclosure, an exoskeleton-based method for determining an estimated slope of a ground surface upon which the exoskeleton is being used is provided. The exoskeleton may have a height and a central axis corresponding to the height and may also include an associated crutch and crutch axis. The method includes providing first data corresponding to a level crutch angle, the level crutch angle corresponding to the angle the crutch axis forms with the central axis upon the exoskeleton being in a standing or walking position on a flat, level surface, providing a database of a plurality of first crutch angels each corresponding to a slope of a ground surface, determining a current crutch angle, the current crutch angle corresponding to the current angle the crutch axis forms with the central axis of the current position of the exoskeleton on a current ground surface upon which the exoskeleton is being used, comparing the current crutch angle to the plurality of first crutch angles of the database to determine the estimated slope of the ground surface, and determining the estimated ground slope of the current ground surface.

In some embodiments of the present disclosure, an exoskeleton-based method for determining an estimated slope of a ground surface upon which the exoskeleton is being used is provided, the exoskeleton having a height and a central axis corresponding to the height and also including an associated crutch and crutch axis. The method includes determining a crutch angle for a plurality of times during operation of the exoskeleton in walking on a ground surface, wherein each crutch angle corresponds to an angle the crutch axis forms with the central axis of a position of the exoskeleton on a ground surface for a specific time upon which the exoskeleton is being used, determining an average crutch angle difference between the plurality of determined crutch angles, upon the average crutch angle difference decreasing, the slope of the surface upon which the exoskeleton is being operated is ascending (going uphill), and upon the average angle difference increasing, the slope of the surface upon which the exoskeleton is being operated is descending (going downhill).

In some embodiments, an exoskeleton-based method for determining an estimated slope of a ground surface upon which the exoskeleton is being used is provided, the exoskeleton having a height and a central axis corresponding to the height and also including an associated crutch and crutch axis. The method includes providing a level crutch angle, the level crutch angle corresponding to the angle the crutch axis forms with the central axis upon the exoskeleton being in a standing or walking position on a flat, level surface, determining a current crutch angle for a plurality of times during operation of the exoskeleton in walking on a ground surface, each crutch angle corresponds to an angle the crutch axis forms with the central axis of a position of the exoskeleton on a ground surface for a specific time upon which the exoskeleton is being used, determining an average crutch angle difference between the plurality of determined crutch angles, and determining the slope of the ground surface by subtracting the level crutch angle from the average current crutch angle difference.

Such embodiments (as well as other embodiments disclosed herein) may additionally include one and/or another of the following functions, functionality, structure, step, and/or clarifications (and if not mutually exclusive, in some embodiments a plurality of, and in some embodiments, a majority of, and in some embodiments, substantially all of, and in some embodiments, all of):
adjusting the posture of the user via the exoskeleton based on the determined slope of the ground surface;
adjusting the posture of the user via the exoskeleton comprises adjusting the angle between at least two elements of the exoskeleton, in some embodiments, the at least two elements comprise each leg of the exoskeleton, components of each leg of the exoskeleton, and a back frame/housing;
crutch angles can be determined by at least one of: image data taken by one or more cameras, one or more accelerometers, one or more gyroscopes, one or more level sensors, any one or more of the foregoing be mounted on at least one of the exoskeleton, a component of the exoskeleton, the crutch, and an accessory;
the accessory comprises a chest worn housing, a smart watch, and a smart phone,
   upon the use of a camera, images produced by the camera are compared to images of known slopes of ground surfaces;
   upon the use of a camera, images produced by the camera are compared to images of known slopes of other surfaces; and
upon the slope of the ground surface being determined, the method further comprises adjusting forces on elements of the exoskeleton, movements of one or more element and/or components thereof, speed of the exoskeleton, speed of one or more element and/or components thereof;

In some embodiments, an exoskeleton-based method for determining an estimated slope of a ground surface upon which the exoskeleton is being used is provided and includes imaging, via one or more cameras provided on at least one of the exoskeleton, one or more components of the exoskeleton, a crutch, and an accessory, analyzing the images to determine one or more angles of any and/or all of the exoskeleton with the ground, the crutch with the ground, and the exoskeleton relative to the crutch.

In some embodiments, an exoskeleton-based method for operating an exoskeleton to step forward via gesture recognition is provided and includes any one or more of the following (in some embodiments, a plurality of the following, in some embodiments, a majority of the following, in some embodiments, substantially all of the following, and in some embodiments, all of the following):
operating an exoskeleton including the use or more crutches;
determining whether the exoskeleton is in walk mode (“(a)”),
upon the exoskeleton being in walk mode, collecting crutch data, the crutch data including at least a position of the crutch;
determining a crutch fall, wherein the crutch fall corresponds to the crutch coming in contact with the ground;
upon the crutch fall being detected, the exoskeleton proceeds to standing mode and then determines whether the crutch is moved to a vertical position in a hand of the user of the exoskeleton, and repeating upon no crutch movement to a vertical position being determined, or, returning to step (a) upon crutch movement to a vertical position being determined;
upon the crutch fall not occurring, monitoring at least one of a forward acceleration of at least one of the exoskeleton and/or crutch is monitored (via an accelerometer, see above), displacement or movement of the exoskeleton and/or the crutch; calculating a speed of at least one of the exoskeleton and the crutch;
determining whether at least one of acceleration, displacement and speed corresponds to a step forward;
upon a step forward determination, calculating a crutch step length and/or speed thereof, otherwise, returning to step (a);
performing a step forward by the exoskeleton.

In some embodiments, an exoskeleton-based method for operating an exoskeleton to step forward via gesture recognition is provided and includes:
operating an exoskeleton including the use or more crutches (“a”);
determining whether the exoskeleton is in walk mode;
upon the exoskeleton being in walk mode, collecting crutch data, the crutch data including at least a position of the crutch; and
determining a crutch fall, wherein the crutch fall corresponds to the crutch coming in contact with the ground.

Such embodiments (as well as other embodiments disclosed herein) may additionally including one and/or another of the following functions, functionality, structure, step, and/or clarifications (and if not mutually exclusive, in some embodiments a plurality of, and in some embodiments, a majority of, and in some embodiments, substantially all of, and in some embodiments, all of):
upon the crutch fall being detected, the exoskeleton proceeds to standing mode and then determines whether the crutch is moved to a vertical position in a hand of the user of the exoskeleton, and repeating upon no crutch movement to a vertical position being determined, or, returning to step (a) upon crutch movement to a vertical position being determined;
upon the crutch fall not occurring, monitoring at least one of a forward acceleration of at least one of the exoskeleton and/or crutch is monitored (via an accelerometer, see above), displacement or movement of the exoskeleton and/or the crutch;
calculating a speed of at least one of the exoskeleton and the crutch;
determining whether at least one of acceleration, displacement and speed corresponds to a step forward;
upon a step forward determination, calculating a crutch step length and/or speed thereof, otherwise, returning to step (a); and
performing a step forward by the exoskeleton.

An exoskeleton-based method for operating an exoskeleton to ascend or descend one or more stairs via gesture recognition is provided and includes:
operating an exoskeleton including the use or more crutches,
determining whether the exoskeleton is in stair mode to ascend or descend a stair (“(a)”),
upon the exoskeleton being in walk mode, collecting crutch data, the crutch data including at least a position of the crutch, determining a crutch fall, wherein the crutch fall corresponds to the crutch coming in contact with the ground,
upon the crutch fall being detected, determining whether the crutch is moved to a vertical position in a hand of the user of the exoskeleton, and repeating upon no crutch movement to a vertical position being determined, or, returning to step (a)—upon crutch movement to a vertical position being determined;
upon the crutch fall not occurring, performing a vertical motion analysis of the crutch movement so as classify such movement as a stair climb;
upon classifying as a stair climb, performing, by the exoskeleton, a stair climb.

Such embodiments (as well as other embodiments disclosed herein) may additionally including one and/or another of the following functions, functionality, structure, step, and/or clarifications (and if not mutually exclusive, in some embodiments a plurality of, and in some embodiments, a majority of, and in some embodiments, substantially all of, and in some embodiments, all of):
a stair climb comprises ascending or descending one or more stairs (“(a)”);
after performing a stair climb, returning to step (a);
vertical motion analysis comprises at least one of a forward acceleration, displacement, and movement of the crutch; and
vertical motion analysis comprises a speed of the crutch;

In some embodiments, an exoskeleton-based method for operating an exoskeleton using gesture recognition is provided and includes:
operating an exoskeleton including the use of one or more crutches,
determining movement of at least one of the crutches via at least one or more sensors provided on at least one of: at least one crutch, the exoskeleton, and a mobile device being used with at least one of the exoskeleton and at least one of the crutches to determine whether the movement of the crutch is in a particular manner; and
wherein upon the determined movement of the crutch is in a particular manner, the exoskeleton is instructed to perform a specific function.

Such embodiments (as well as other embodiments disclosed herein) may additionally including one and/or another of the following functions, functionality, structure, step, and/or clarifications (and if not mutually exclusive, in some embodiments a plurality of, and in some embodiments, a majority of, and in some embodiments, substantially all of, and in some embodiments, all of):
the specific function comprises any and all of (or a plurality of):
   perform or change of mode of operation;
   modifying the forces applied by one or more motors on one or more exoskeleton elements and/or components of such elements;
   modifying a speed of movement of the exoskeleton and/or one or more components of the exoskeleton and/or components of such elements;
   modifying a distance of movement of the exoskeleton and/or one or more components of the exoskeleton and/or components of such elements;
   modifying relative angular movement between two elements of the exoskeleton and/or components of such elements; and
   modifying a timing of movement of the exoskeleton and/or movement of one or more components of the exoskeleton and/or components of such elements; and
the one or more sensors comprise at least one of: one or more cameras, an accelerometer, a gyroscope, an ultrasonic sensor, radar and LIDAR.

An exoskeleton-based method for autonomous curb/stair ascend in operating an exoskeleton is provided and includes any one or more of the following (in some embodiments, a plurality of the following, in some embodiments, a majority of the following, in some embodiments, substantially all of the following, and in some embodiments, all of the following):
determining whether an exoskeleton is in a walk mode (“(a)”);
upon being in a walk mode, determining whether one or more steps/stairs are in an immediate area where the exoskeleton is being operated;
optionally alerting the user of the exoskeleton that a step has been determined to be in the immediate area;
estimating a distance to the step and/or display an/the estimated distance to the user;—upon the estimated distance not being less than a first predetermined distance, the method returns to step (a);
upon the estimated distance being less than first predetermined distance, determining if the step is less than a second predetermined distance away;
upon the step not being less than a second predetermined distance away, reducing the steps size of the exoskeleton;
determining whether the user has caused the operation of the exoskeleton to stop walking, if the user has not caused the operation of the exoskeleton to stop walking, the method returns to step (a);
upon the user causing the operation of the exoskeleton to stop walking, determining whether the step distance is less than a third predetermined distance, wherein if the step is not within the third predetermined distance, the method returns to step (a);
upon the step distance being within the third predetermined distance, determining a height of the step;
if the step height is within a predetermined range, a step detection event is triggered; and
upon the user causing the exoskeleton to perform climb up the step, which may comprise selecting an icon, pressing a button, or via verbal or glancing look via smartglasses, perform at least one step climb and transition to stand mode (“(1)”).

Such a method embodiment(s) may further include repeating step height determination unless the exoskeleton has returned to a floor position at which point the method returns to step (1).

One of skill in the art will appreciate that any and all sensors disclosed here can be used to aid in the disclosed functionality, systems, devices, apparatuses, and methods disclosed.

These and other embodiments, objects, features and advantages are presented below in the detailed description and the provided for drawings, a brief description of which is provided below.

### BRIEF DESCRIPTION OF THE DRAWINGS

FIG. 1A is a side, perspective front view of an exoskeleton device without a user, according to some embodiments of the disclosure;

FIG. IB is a side perspective rear view of an exoskeleton device without a user, according to some embodiments of the disclosure;

FIG. 1C is a front view of an exoskeleton device with a user, according to some embodiments of the disclosure;

FIG. ID is a rear, side, perspective view of an exoskeleton device without a user, and detached leg element, according to some embodiments of the present disclosure;

FIG. IE is a rear, side, perspective view of an exoskeleton device without a user, illustrating a battery/power source attachment, according to some embodiments of the present disclosure;

FIG. IF is a front, side, perspective view of an exoskeleton device without a user, illustrating an adjustable back support element, according to some embodiments of the present disclosure;

FIG. 1G is a rear view of a housing for an exoskeleton device which houses at least electrical circuitry (including digital and/or analog), as well as a power source(s), according to some embodiments of the present disclosure;

FIG. 1H is a crutch device for use with an exoskeleton according to some embodiments of the present disclosure,

FIG. 2A is a rear, side, perspective view of an exoskeleton device with a user, according to some embodiments of the disclosure;

FIG. 2B is a front, side, perspective view of an exoskeleton device with a user, according to some embodiments of the disclosure;

FIG. 2C is an example of a chest-worn element for housing one or more sensors for gathering data on surroundings/environment in which an exoskeleton is being used, according to some embodiments of the disclosure;

FIG. 2D is a picture of a user of an exoskeleton, in a seated position, utilizing a pair of smart glasses as a user-interface (or part of a user interface), for displaying exoskeleton data or data related to the operation and use of an exoskeleton and/or controlling the exoskeleton, according to some embodiments of the present disclosure;

FIG. 3 is a block diagram illustrating components and functionalities associated with exoskeleton systems according to some embodiments of the present disclosure;

FIG. 4 illustrates a process/block diagram illustrating various modes of the exoskeleton and associated methodology associated therewith, according to some embodiments of the present disclosure.

FIG. 5 illustrates a block diagram illustrating an overview of an exoskeleton system according to some embodiments of the present disclosure and communications therebetween;

FIGS. 6A-E are simple diagrams illustrating a methodology for surface slope detection according to some embodiments of the present disclosure, with FIGS. 6A-B corresponding to an overview of an uphill slope determination, FIGS. 6D-E corresponding to a downhill slope determination, and FIG. 6C corresponding to the difference in angle (see below), for ultimately determining the slope angle of the surface upon which the exoskeleton is being operated.

FIGS. 7A-B are flowcharts illustrating processes for gesture recognition for operating and/or controlling an exoskeleton according to some embodiments of the present disclosure;

FIG. 8 is a flowchart illustrating a process for autonomous curb/stair ascend/descend, according to some embodiments of the present disclosure;

### DETAILED DESCRIPTION OF THE INVENTION

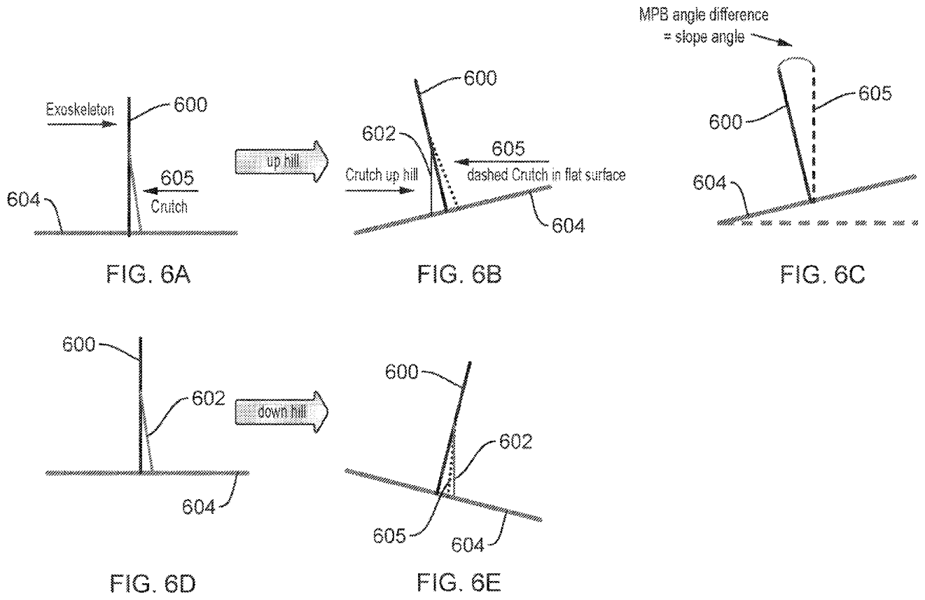

Various figures illustrate structure, functionality, and/or methodology for current embodiments of the subject disclosure, including, for example, exoskeletons and features thereof, electronic/processor architecture (which can include intent recognition means/block, context detection means/block, user-interface, trajectory/movement means/generator (which can include motion control), and safety/adaptive autonomy means/block (see, e.g., FIG. 6B).

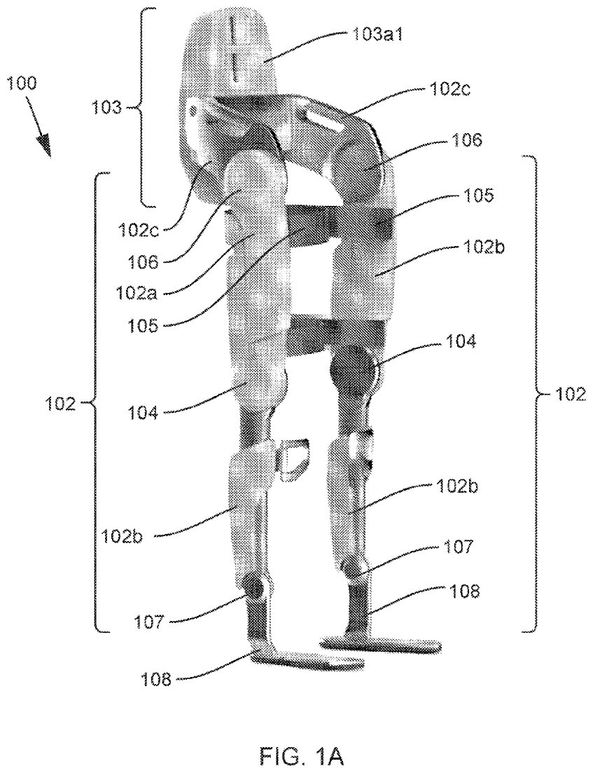

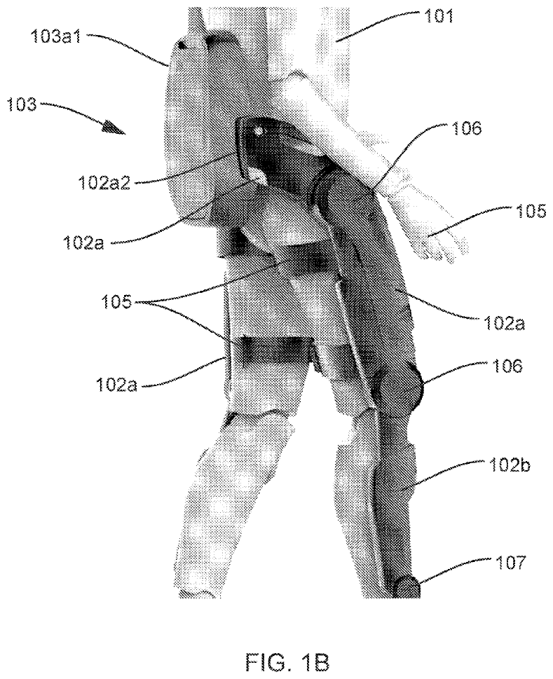

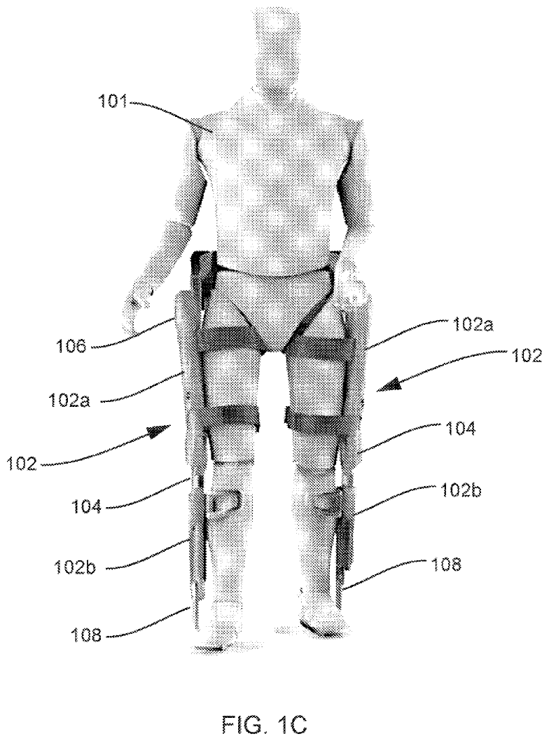

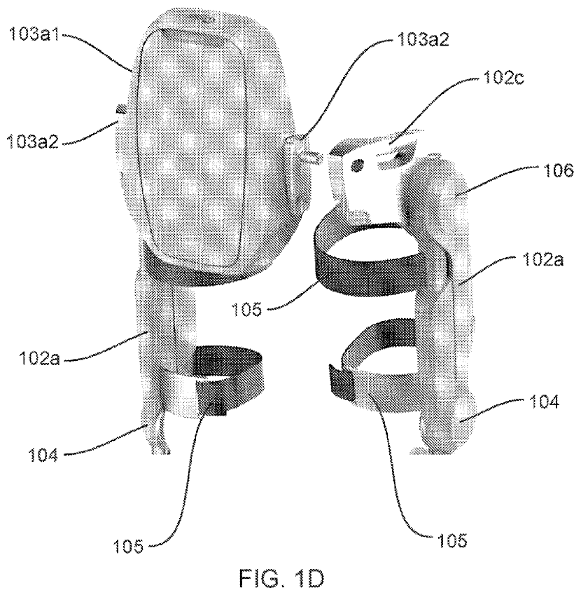

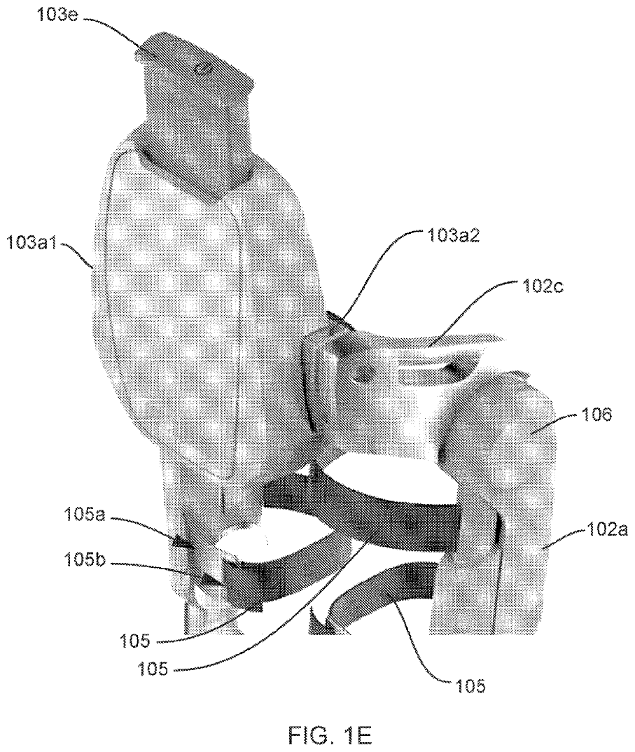

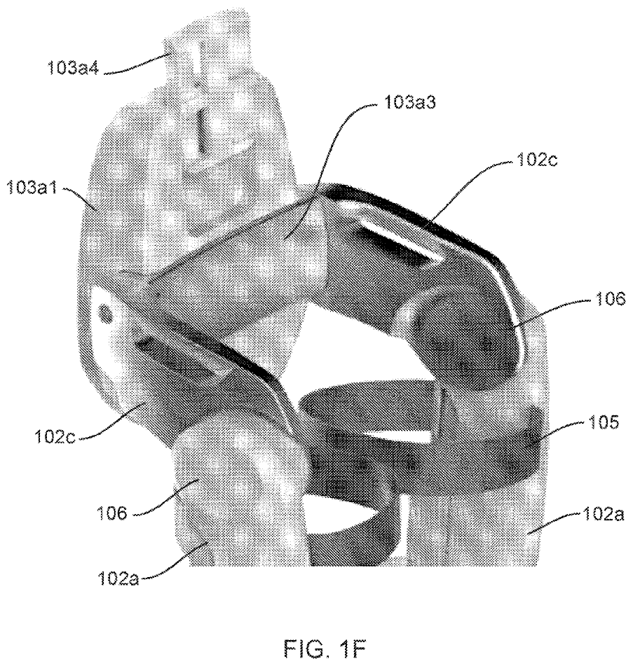

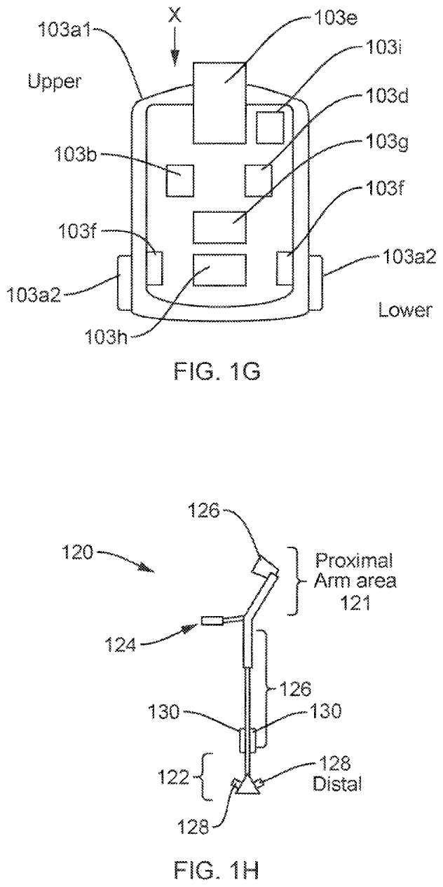

Accordingly, as shown in FIG. 1A-1G, an exoskeleton 100 (shown with a human body) can include leg elements 102 and body frame 103, which includes a housing 103a1 and frame 103a3 with ends 103a2 (or other structural support member to which leg elements 102 are attached and/or provide reinforcement for the exoskeleton, in some embodiments). The exoskeleton 100 can also include knee joints 104, each of which can located between an upper leg element 102a and a lower leg element 102b of respective leg elements 102, hip joints 106 each of which can be located between upper leg elements 102a and upper connection elements thereof 102c for each leg element 102, and ankle joints 107 which can be located between each lower leg element 102b and respective foot elements 108. Leg straps 105 enable each leg element to be removably attached to the legs 109 of a user 101. The straps my include a metal or more rigid portion attached to respective leg elements, and a fabric (natural or synthetic) portion which can be threaded through a slot in the metal portion (e.g., using Velcro and/or other removable affixation structure) which allow a leg to be attached to respective leg elements of the exoskeleton. Each joint, as noted above, allows for relative motion between connected elements.

As shown in FIGS. 1E-F, each of which is a backside, perspective view of the housing, the battery 103e is shown as removable from a recess or slot provided in the top part housing 103a1, which is received within the interior of the housing. The recess may actually be arranged on a surface on any side of the housing or may simply attach or “plug-in” to the housing via an electrical connection element (not shown). Additional batteries may be provided within the housing or in other recesses provided on the outside (or inside) of the housing. FIG. IF illustrates an adjustable back support element 103a4, which can be adjusted for height depending upon the user and is received and adjustable via a recess in the front side of the housing 103a1.

Housing 103a1 can include a removable cover 109 to access the interior of housing 103a1. One of skill in the art will appreciate that while the cover is shown to cover a rear area (relative to where a human would be positioned) of the housing, a cover can be provided anywhere on the housing. However, in some embodiments, given the relative importance of access to the inside of the housing, especially when the exoskeleton is being used, the cover is arranged on the rear side of the housing facing away from the user 101. Accordingly, with the cover removed, electrical (and in embodiments, structure—e.g., frame and/or other support elements) provided within the housing which, in some embodiments, provide operation, control, power, data processing, and communications between such elements and other elements and/or devices/systems, including one or more crutches, mobile phones, and a remote server and the like and process data. As shown in FIG. 1G, such elements within the housing can include power source/battery(ies) 103e, one or more motors 103f to provide motion to the leg elements 102 (although in some embodiments, such a motor(s) can be accommodated in the upper leg element 102 proximate or in/around hip joint/area 106), CPU/controller 103b which controls the exoskeleton in different modes (e.g., sit, stand, walk, stair climb, and the like). The controller 103b can be connected to and/or communicate with memory 103c and transceiver 103d. The housing may also include an IMU(s) 103h which can communicate with other circuitry/elements to provide data (environment, movement, speed, and the like) to the CPU (and/or other processors) to aid in the control and operation of the exoskeleton. The housing may include an audio component 103i, e.g., a speaker (which may also be located on a control/user interface of a crutch, and/or other component of the exoskeleton) for providing audible alerts which may be in the form of spoken words. While not shown, the internal elements of housing 103a1 can be mounted on a printed circuit board (which can be the base element for circuitry within the housing), which includes wire connections between elements (e.g., CPU, IMU, power, transceiver, memory, and the like). A visual alert can be provided via the various disclosed user-interfaces, or a simple light or display mounted anywhere that a user can see it (on the exoskeleton, on the write, on the crutch on a smartphone removably affixed to the exoskeleton or crutch.

The transceiver 103d allows the exoskeleton and/or controller to communicate with at least one of an external device (e.g., a selector device to operate the exoskeleton), a gateway device, a computing device (e.g., smart phone, personal computer, remote server). In addition, one or more sensors provided on or within the exoskeleton and/or components thereof, can communicate with the controller to provide real time (or near real time) data on conditions surrounding the exoskeleton, as well as data on components (e.g., temperatures of motors, electronic elements, and power; stresses being experiences by elements or between elements of the exoskeleton, and the like), as well as other sensors familiar to those of skill in the art. Other electronic components, either digital or analog or both, can be accommodated in this housing as well, and referred to as additional circuitry 103g (e.g., memory, additional processors, accelerometer(s), gyroscope(s), GPS unit(s), and the like). As indicated in FIG. 1G, the housing has an upper portion labeled “Upper” and a lower portion labeled “Lower”.

In some embodiments, the exoskeleton can include one or more crutches, an example crutch 120 is shown in FIG. 1H (thus, in the subject disclosure referring to a single crutch is a matter of convenience, and thus, embodiments directed to a crutch, or an exoskeleton system which includes an exoskeleton and a crutch, such may be a plurality thereof). Such a crutch can include an arm receiving potion 12. Such crutches can be those as describe in International PCT publication no. WO2014111921 A1, as well as U.S. Pat. No. 11,344,467, and US patent publication no. 20120101415A1, each of the foregoing disclosures are herein incorporated by reference in its entirety. To this end, such crutches and the like can be stand-alone crutches, or crutches connected to the exoskeleton or other device (e.g., a walker), and can include interfaces for crutch(es) and/or an exoskeleton.

Accordingly, crutch 120, which can be a forearm crutch as illustrated, includes a distal tip 122, a forearm support 121, a grip 124 extending out from a main portion 126 of the crutch. The crutch may be adjustable in height, and/or grip extension distance. An upper portion of the forearm support includes an arm clip 126. In some embodiments, the grip and/or an area around the grip can include a user interface which may comprises a touch screen and/or physical buttons and switches for operating the exoskeleton (e.g., selection of modes—stand, sit, collapse, walk, stair/curb, climb, and the like), and various other sensor based functionality (for example).

In some embodiments, the crutch can include one or more sensors along portions thereof. For example, a sensor(s) 128 can be provided on or near the tip 122 (while the figure illustrates two such sensors, it is merely for example, and one or more are within the scope of the disclosure). Similarly, a sensor(s) 130 can be located at a midway point up the lower shaft of the crutch. In some embodiments, the sensor(s) 128 can be an LED(s), and the sensor(s) 130 can be a photodiode(s) for receiving light emitted from one or more LEDs reflected off a surface.

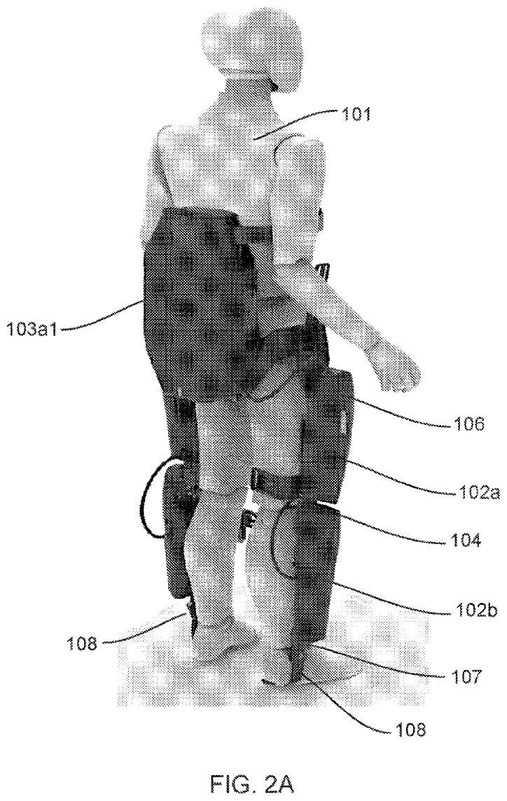

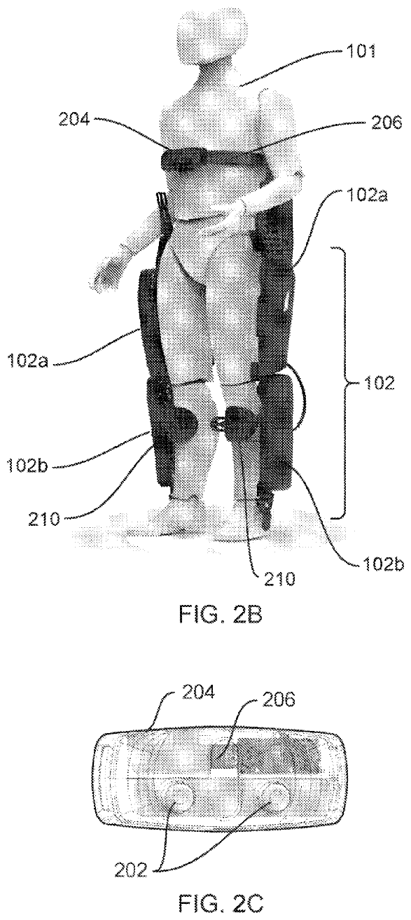

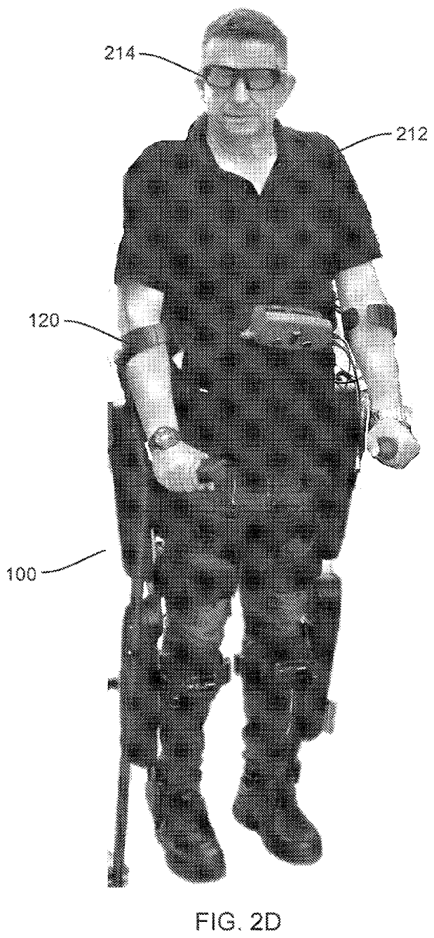

FIGS. 2A-C illustrate an exoskeleton system, similar to the embodiments shown in FIG. 1 A-1F, but also additional structure for use in providing data to the exoskeleton system or one or more associated processors, and can include, for example, a high-resolution sensor including any one or more of LIDAR, radar, ultrasonic and imaging. With respect to imaging, in some embodiments it can be full spectrum or partial spectrum (e.g., visible, infra-red). As shown in the figures, the exoskeleton can include a pair of stereoscopic cameras 202 (in some embodiments, a single camera can be used) as part of a chest-worn or exoskeleton mounted sensor element 204. The chest-worn or exoskeleton mounted element may be attached to the user via a strap 206, for example or using a rigid structure to the exoskeleton. Additional sensors as part of chest-worn or exoskeleton mounted sensor element 204 can include, for example, a radar sensor 206 (e.g., 60 GHz), as well as circuitry 208 which can include communication elements to communication with the IMU or CPU/controller and/or other processor to pass along data collected (raw and/or processed data); such communications may be wired to the exoskeleton, or, via wireless (e.g., Bluetooth which can be referred to as BLE, Wi-Fi and the like). Other structure mounted to other parts/portions of the exoskeleton can be lower leg mounted housings 210 (which can be mounted, either permanent or removable, to lower leg element 102b), and can includes ultrasonic and/or infrared sensors, LEDs, photodiodes, and the like (as well as in some embodiments a camera(s)), to collect data regarding the surrounding in which the exoskeleton is used. Any one or more of these sensors (in some embodiments, a plurality of such sensors, in some embodiments, a majority of such sensors, in some embodiments, substantially all of such sensors, and in some embodiments, all of such sensors) can be used to sense the surroundings/environment in which the exoskeleton is being used, including, in some embodiments, determine where inclines or declines may be being approaches, as well as stairs, curbs, rough or slippery surfaces and the like.

FIG. 2D illustrates a user 212 in a seated position using smart glasses 214, which can be used for user control of the exoskeleton.

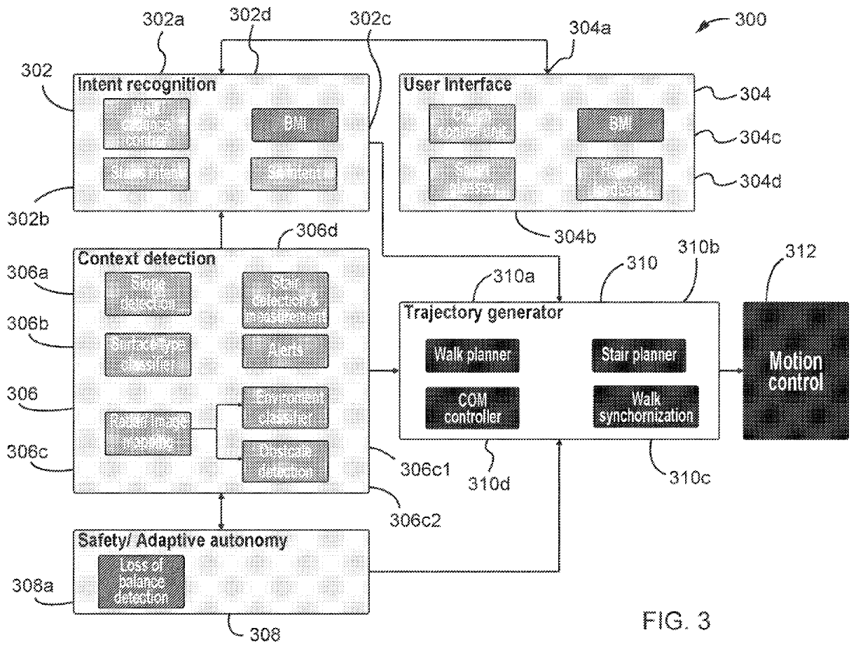

FIG. 3 is a block diagram 300 illustrating components and functionalities associated with exoskeleton systems according to some embodiments of the present disclosure. As shown, Intent recognition module 302 includes a walk cadence control sub-module/function 302a, a stairs-intent sub-module/function 302b, a sit-intent sub-module/function 302c and can also include a brain-machine interface sub-module/function 302d for interfacing directly with a user's brain (e.g., user worn EEG sensors and/or one or more neuro-implants which can communicate with the exoskeleton and accessories thereof for controlling the same through thought). In some embodiments, the intent recognition module performs gesture recognition where movements by the user (e.g., movement of a crutch(s)) can correspond to transitioning modes of the exoskeleton for example. Accordingly, as shown, the intent recognition can be, in some embodiments, a user-interface 304 or at least a component thereof. As shown, the user interface module 304 can receive or transmit information from/to the intent recognition module 302.

The user-interface module 304 can include, in some embodiments, a crutch control sub-module/function 304a, smart-glasses sub-module/function 304b (see ref. no. 214 of FIG. 2D), a BMI 304c (see above), and haptic feedback sub-module/function 304d (such can be included in the circuitry of housing 103a1, and/or via a smart watch (or other write mounted element), or in the grip of the crutch or elsewhere on the crutch).

Context detection module 306 includes sub-module/function slope detection 306a (see below), a surface detection sub-module/function 306b (see below), radar/LIDAR/image mapping sub-module/function 306c which can also be part of an environmental classifier sub-module/function 306c1 (rain, ice, snow, temperature, wind and the like, in some embodiments) as well as part of an obstacle detection sub-module/function 306c2. The context detection module 306 can also include stair detection and/or measurement sub-module/function 306d (see below), and an alert sub-module/function 306e, for generating alerts to convey information e.g., selection of functions/mode, emergency situations, a collapse mode, a falling situation, and the like). The context detection module 306 can, in some embodiments, communication with the intent recognition module 302, a safety/adaptive autonomy module 308 and a trajectory generator module 310.

In some embodiments, the safety/adaptive autonomy module 308 includes, for example, a loss of balance sub-module/function 308a, which is configured, based on data/information supplied by one or more sensors, whether the exoskeleton has lost (or is in danger of losing) balance. For example, if a sensor(s) detects an angular stance of the exoskeleton is beyond a certain threshold (e.g., more than 10 degrees, more than 20 degrees, more than 30 degrees, more than 45 degrees) from vertical, or that images collected from a camera(s), radar, or LIDAR indicate an immanent or likely fall due to the loss of balance.

The trajectory generator 310 can include a walk-planner 310a sub-module/function and/or a stair planner sub-module/function 310b, which, in some embodiments, determines at least one next step timing and/or movement (in one, two, or three dimensions) of at least one of the leg elements and/or components thereof, relative to another, including, in some embodiments, relative to other structure of the exoskeleton (e.g., housing, frame, and the like), a walk-synchronization 310c sub-module/function, which can be used to synchronize movements of leg elements to effect walking in a relatively smooth manner. The trajectory generator 310 can also include a center of mass (COM) controller, which monitors the center of mass of the exoskeleton from sensor(s) data.

In some embodiments, a motion control module 312 communicates with the trajectory generator 310 and can be used to control/operate various motors (for example), actuators and the like to effect movement of the exoskeleton according to instructions provided or commanded, including, for example, selection of modes (e.g., walk, sit, stand, stair climb/ascend/descend, collapse, stop, and the like).

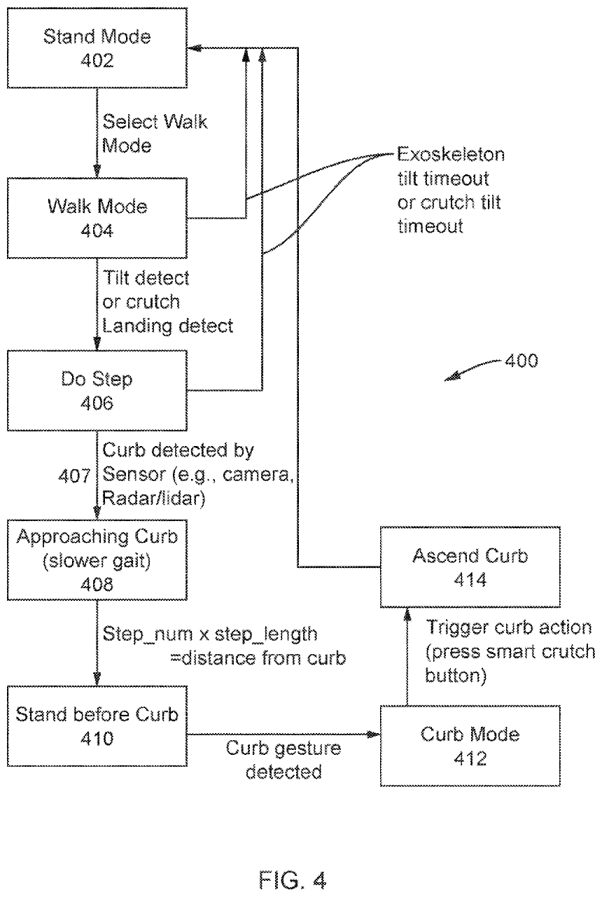

FIG. 4 illustrates a process/block diagram 400 on various modes of the exoskeleton and associated methodology associated therewith, according to some embodiments. As shown, when the exoskeleton is in a stand mode 402, the user can selected a walk mode 404, and once selected, if the user doesn't move (e.g., tilt) a crutch and/or the exoskeleton (e.g., leaning forward COM change), such movement being sensed by accelerometers or imagery provided by one or more corresponding sensors in the crutch(es) and/or skeleton, the process times out and the exoskeleton returns to stand mode 402. However, upon such movement being detected, the exoskeleton (e.g., via motion control, and/or other modules, see FIG. 3), performs a step 406 by, for example, swinging one leg element forward, and continues at predetermined speed/gait. However, in some embodiments, at any time if a tilt or movement of a crutch(es) and/or lean of the exoskeleton is not sensed, the process returns to a stand mode.

Accordingly, in walk mode, and with one or more sensors gathering data (e.g., images, radar/LIDAR, ultrasonic, spectrometry), and a curb is detected, the speed/gait of the exoskeleton slows as the exoskeleton approaches the curb at step 408, with the distance from the curb being estimated based on the number of steps away from the curb multiplied by the step length of the exoskeleton for a particular user (or in some embodiments, a universal step length), equals the distance. Upon the exoskeleton being within predetermined distance from the curb, in some embodiments, a single step from the curb (in some embodiments, less than a step away), the exoskeleton enters stand mode 410. Upon user input (via, for example gesture recognition, see below), the exoskeleton enters curb mode and within predetermined period of time (e.g., less than 10 seconds, less than 5 seconds, less than 3 seconds), ascending curb mode is triggered 412 (in some embodiments, the triggering of curb mode may be via button located near the grip area on a crutch(es)). Thereafter, the exoskeleton ascends the curb 414, and thereafter, the exoskeleton enters stand mode 402.

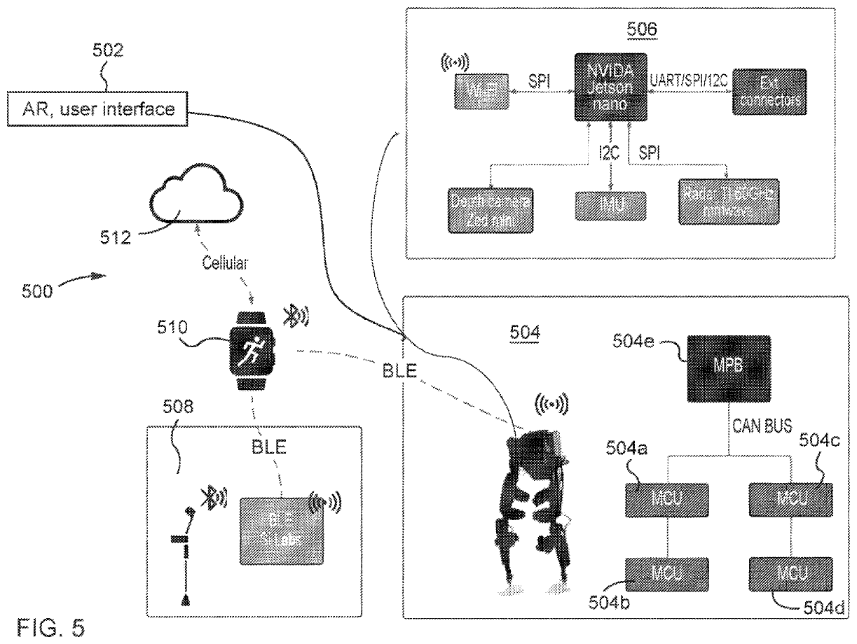

FIG. 5 illustrates a block diagram 500 illustrating an overview of an exoskeleton system according to some embodiments of the present disclosure and communications therebetween via, for example, Bluetooth (BLE), and/or Wi-Fi. In particular, and according to some embodiments, a user interface 502 (which can be an augmented reality interface via smart glasses), can communicate with the exoskeleton 504, and in particular, with any and all of one or more of micro-control units 504a-d, and main processing board (MPB) 504e.

The exoskeleton 504 can communicate with other accessories like the chest-worn sensor(s) device 506 (see also, FIGS. 2A-2C) via Wi-Fi or Bluetooth, as well as communications, in some embodiments via Wi-Fi and/or Bluetooth to a smart crutch(es) 508, and/or a smart watch 510 (e.g., Apple Watch). The watch (or any of the exoskeleton and smart crutch via a cellular communications module provide in each, in some embodiments) can be connected to a cellular network 512 (or other wide area or local area network) other remote devices, and therefore, in some embodiments, communication information from any of 502, 504, 506 and/or 508.

### Surface Detection

As shown in various figures (e.g., FIGS. 2A-C, 3), in some embodiments, the exoskeleton (or other orthotic device/system, together referred herein to “exoskeleton”), and/or at least one corresponding crutch device for use therewith, includes an spectrometry analysis system or device (e.g., an infrared (IR) system, or “surface detection system” or “SDS”), and method configured to, inter alia, detect a ground or floor surface the exoskeleton interacts with, including, for example, in indoor areas: carpeting, ceramics, and tile, and in outdoor areas: grass, dirt, concrete, brick, stone, and asphalt, as well as wet, snowy or icing conditions of any of the foregoing. In some embodiments,

In some embodiments, another technique for surface type detection (or supplementary to other techniques disclosed herein) involves classifying IMU data form a crutch(es) and/or exoskeleton using pretrained AI models.

Accordingly, in some embodiments, the IR system can include one or more and preferably, a plurality of light-emitting-diodes (LEDs) (e.g., see FIG. 1H, the elements of which for sensing can instead by used on element 210). Such LEDs can be visible and/or infrared spectrum configured. To this end, one or more (and preferably a plurality) of the LEDs are activated by the system to illuminate a surface upon which the exoskeleton is being used. One or more photodiodes can be provided on a component or part/portion of the exoskeleton (e.g., leg element(s) 102), and/or a crutch(es). The photodiodes are configured to measure the LED light reflected off the surface, and in some embodiments, measure the wavelength(s) thereof. The measured value(s) that are collected can then be processed via a processor or internal mapping unit (“IMU”) 103h (which, in some embodiments, can be the CPU/controller 103b and/or used in combination therewith), in which the values are compared to data from a lookup table in memory in communication with the IMU (or data stored in memory on a remote data base via a remote or connected device—e.g., mobile phone, remote server), of known values for a variety of surfaces, so as to identify the surface. In some embodiments, surfaces can include not only ground, but also vertical or angled surfaces and/or objects (e.g., walls, steps). In some embodiments, the identification of a surface of the environment that the exoskeleton is being used occurs in real-time (one of skill in the art will understand that “real-time” is either happening at the same time or nearly at the same time; in some embodiments, nearly at the same time is that which is within a small period of time—e.g., in some embodiments, within seconds, within a second, within a fraction of a second).

Accordingly, based on the identified surface, the exoskeleton, components thereof, and/or accessories for use with the exoskeleton (e.g., one or more crutches) can change a “mode” (e.g., stop, walk, run, stand, sit, collapse), and/or adjust any one or more of:
forces applied by one or more motors on one or more exoskeleton elements (e.g., one and/or both of leg elements 102 and/or components thereof);
speed of movement (e.g., walking) of the exoskeleton and/or one or more components of the exoskeleton (e.g., one and/or both of leg elements 102 and/or components thereof);
a distance of movement of the exoskeleton and/or one or more components of the exoskeleton (e.g., one and/or both of leg elements 102 and/or components thereof), including angular movement (e.g., angles between upper and lower leg elements, see below);
timing of movement of the exoskeleton and/or movement of one or more components of the exoskeleton (e.g., one and/or both of leg elements 102 and/or components thereof); and
an angle(s) between elements of the exoskeleton (e.g., one and/or both of leg elements 102 and/or sub-components thereof).

In some embodiments, the IMU can also include, or receive output or communications from, an accelerometer and/or a gyroscope (which can be a part of the IMU or the CPU/controller, or circuitry module 103g (see above). The data from at least one can also be used for determining a surface and/or conditions thereof, either alone, in combination, and/or in combination with data from the SDS system. Specifically, movement patterns (including positioning of the exoskeleton, or components thereof) can be determined by the accelerometer and/or gyroscope so that such data can determine a walking pattern of the exoskeleton, which in some embodiments, a walking pattern(s) can be used to determine, or at least help identify a surface or condition thereof.

The detection of surface conditions is paramount to optimal performance of an exoskeleton, as well as safety of the user of the exoskeleton, and in some cases, individuals who are located near the exoskeleton during use.

As discussed, detection of surface types, in some embodiments, changes the forces and movements provided by the exoskeleton. Accordingly, each surface type, in some embodiments, corresponds to a specific set of forces and/or movements by the exoskeleton and/or a crutch(s) (in some embodiments, including speed changes). Thus, in some embodiments, the identification of the surface, the stability of use of the exoskeleton is increased relative to an exoskeleton with a single set of forces/movements for a particular mode (e.g., see above) depending upon the surface encountered.

In some embodiments, the SDS can be or can include a portable electronic device mounted on, for example, a bottom of an exoskeleton accessory, for example, one or more crutches (FIG. 1H). Such embodiments can include one or more (and in some embodiments, a majority of, in some embodiments, substantially all of, and in some embodiments, all of) the components noted above to enable the operation of the SDS, including, for example, any and all electronic circuitry (digital and/or analog) to preform spectrum analysis using the LEDs and photodiode(s) and can also include the internal mapping unit or IMU for detecting a walking pattern and/or any crutch encounters with a surface.

In some embodiments, at least one camera 202 may be used, either in place of the LED/photodiode combination, or in addition thereto; FIG. 2C illustrates the camera as part of a chest worn housing (one or more sensor(s), including all sensors, can be mounted on the exoskeleton and/or a crutch(es)). In this respect, images can be collected (either still or video) and compared to imagery for various surfaces and/or conditions thereof stored in memory (see above). In some embodiments, artificial intelligence (AI) can be used such that the AI can be trained on images of different surface types, to produce data for the lookup table. Moreover, data gathered by the SDS can be used with AI to further train the AI on surface types or conditions of surfaces. This can then be used by the SDS to select the correct forces, movements, and speed (at least one, and preferably a plurality, and preferably all) for the exoskeleton to follow, in some embodiments, such selection (and/or training) can be done automatically.

While the above-noted surface detection functionality is described as for detecting types of surfaces, such embodiments can also be used to detect surfaces of obstacles in the area (or close to the area) of where the exoskeleton is being used. Thus, the disclosed adequately supports surface type detection to detect obstacles.

### Surface Slope Estimation

In some embodiments, the IMU 103h (and/or the CPU/Controller 103b) can be configured to detect an orientation of the exoskeleton 100, and/or an orientation of one or more accessories (such as one or more crutches) used with the exoskeleton system, within an environment or space. Such orientation determination can be configured to determine a slope of a surface in degrees (for example), on or near the exoskeleton or accessories (e.g., crutch(es)). For example, in some embodiments, the accelerometer(s) and/or a gyroscope(s) provides acceleration, angular velocity (e.g., between elements of the exoskeleton and/or accessories—e.g., a crutch(es)), and/or orientation data, respectively, for use by the IMU to analyze a walking pattern of the exoskeleton (for example), and crutch orientation, preferably in a continuous fashion, in a space on or surrounding the exoskeleton/crutches to estimate the slope of the surrounding surface and/or changes thereof. Walking patterns include, for example: speeding up of walking, speeding up of leg movements of the exoskeleton, and the like, and weight of the user and/or exoskeleton (and/or accessories, e.g., one or more crutches), the angle of the slope can be determined. Accordingly, similar to surface recognition, based the determined on the determined slope of the surface, the exoskeleton, components thereof, and/or accessories for use with the exoskeleton (e.g., one or more crutches) can change a mode (e.g., stop, walk, run, stand, sit, collapse), and/or adjust any one or more of the following:
forces applied by one or more motors on one or more exoskeleton elements (e.g., one and/or both of leg elements 102 and/or components thereof);
forces applied by one or more exoskeleton elements;
speed of movement (e.g., walking) of the exoskeleton and/or one or more components of the exoskeleton (e.g., one and/or both of leg elements 102 and/or components thereof);
a distance of movement of the exoskeleton and/or one or more components of the exoskeleton (e.g., one and/or both of leg elements 102 and/or components thereof); timing of movement of the exoskeleton and/or movement of one or more components of the exoskeleton (e.g., one and/or both of leg elements 102 and/or components thereof); and
an angle(s) between elements of the exoskeleton (e.g., one and/or both of leg elements 102 and/or components thereof).

Any or all of the above can be changed (in some embodiments, automatically) to address the inclination of surface upon which the exoskeleton is being used so as to increase safety for the user of the exoskeleton and people in proximity to the exoskeleton. By changing one or more of the parameters outlined above, the speed of the exoskeleton can be increased or decreased, or even stopped to protect the user and nearly individuals, and/or enable the exoskeleton to be more efficient—for example—enabling the exoskeleton to get to a destination safer (and, in some embodiments, quicker and safer) based on the slope of the surface upon which the exoskeleton is traveling. Changing the parameters outlined above, in some embodiments, preserves the exoskeleton center of mass as close to the center of mass (COM) on a flat surface.

FIGS. 6A-E are simple diagrams to help illustrate slope detection methodology according to some embodiments. FIGS. 6A-B correspond to the overview of an uphill slope overview, and FIGS. 6D-E are a downhill slope overview. FIG. 6C corresponds to the difference in angle (see below), for ultimately determining the slope angle of the surface upon which the exoskeleton is being operated. Line 600 represents the exoskeleton (and/or a central axis thereof), line 602 represents a crutch (and/or a central axis thereof), line 604 represents the ground surface upon which the exoskeleton is being operated, dashed line 605 represents the crutch angle relative to a flat, level surface 606 (e.g., a central axis of the crutch relative to the flat, level, surface).

Initially, data corresponding to a crutch angle 608 (crutch angle data) relative to the exoskeleton 600 is collected. Data is also provided or determined on what a crutch angle corresponds to use of the exoskeleton on a flat, level surface. In some embodiments, machine learning/AI can be used to provide inference. Machine learning/AI can assist to classify whether a specific user on an incline (of a flat surface) by utilizing current sensor(s) data (e.g., IMU, encoders, currents and exoskeleton mode). Such can also be used to help classify whether the exoskeleton is in a stand or walk mode on a flat, level surface (or any other mode, e.g., stair climb).

In some embodiments, collected angle data is compared to a lookup table of values for angles which correspond to slope values, that is, corresponding angles of the surface upon which the exoskeleton is being operated. The data for the lookup tables can be produced via machine learning/AI in which data is previously collected for a plurality slope angles (relative to the exoskeleton), and for each slope angle, a plurality of potential crutch angles that may correspond to such slope angles. To this end, such data is collected for a plurality of users, as well as data for each user, including, at least one of, and for example, height, weight, arm length, leg length, age, and gender, and used in AI training to determine the lookup table data. To this end, in some embodiments, data of the user of the exoskeleton (see above, height, weight, and the like) is determinative of the lookup table data used to determine the slope of the surface upon which the exoskeleton is used.

However, in some embodiments, after collecting crutch angle data, and classifying a mode of the exoskeleton on flat, level surface (e.g., walk or stand), the average angle difference between the crutch and the exoskeleton is determined. If the average angle difference is decreasing, the slope of the surface upon which the exoskeleton is being operated is going uphill. If the average angle difference is increasing, the slope of the surface upon which the exoskeleton is being operated is going uphill.

Accordingly, in some embodiments, subtracting the crutch angle for a flat surface from the average angle difference, the slope of the surface upon which the exoskeleton is being used is determined.

Thus, the determination of surface slope and changes thereto can provide increased stability for an exoskeleton, avoiding, in some embodiments, the user to have a higher cognitive value to maintain balance (i.e., lowering the risk of a fall). Moreover, in some embodiments, based on output from the IMU, the exoskeleton can adjust posture (i.e., one or more positions of one or more leg elements and/or components thereof) to accommodate the determined slope (and again, lessening the chance that the exoskeleton/user will fall).

In some embodiments, at least one camera may be used, either in place of or in addition to other sensors provided on the exoskeleton or crutch (and/or the components thereof). In this respect, images can be collected (either still or video) to determine the slope upon which the exoskeleton is being used (or will encounter) by ascertaining positions of a crutch(es) relative to the exoskeleton and/or ground (as well as determining the ground), and then determining the slope (in some embodiments, using the above noted process). In some embodiments, using images, the IMU or other processor can simply determine the slope of the surface by comparing the images to images of known slopes of ground surface.

In some embodiments, using artificial intelligence (AI) trained on images of different slope amounts/angles, the AI can determine the slope angle (or closely approximate) that the user is or will be encountering, and provide the slope angle to the exoskeleton CPU to then select the correct posture (and/or forces, movements, and speed; at least one, and preferably a plurality, and preferably all) for the exoskeleton to follow (e.g., see paragraph [0046]).

### Gesture Recognition—Perception and Context Awareness

In some embodiments, a crutch used with an exoskeleton (which can also include functionality as described above and/or additional functionality) is configured to detect and determine a user's will to enter a mode of an exoskeleton, including for example, sit, stand, walk, and stairs (and the like). Such functionality can be referred to as “gesture recognition” and increases safety and ease of use of an exoskeleton for a user.

For example, upon an exoskeleton user approaching a stair or a curb and stops in front of it, the user may need to adjust position in a forward direction in order to be able to climb the stairs or curb. Such movement to perform a stair operation can require up to one (1) meter (or even more) of forward movement and thus, some users may not be able to perform such a physical maneuver.

Accordingly, in some embodiments, as the user approaches a stair, the user selects a “stair” mode, and then by moving a crutch forward, is an indication to the exoskeleton of a length required to be aligned with the stair; this enables location tuning for the exoskeleton (and, in some embodiments, the crutch(es)). Similarly, in some embodiments, other gestures can be used for other modes of operation (as indicated above), including and for example, sitting, standing, walking and the like. Such embodiments enable ease of use of an exoskeleton both cognitively and physically, leading to an increase in safety and effort (and use of an exoskeleton by wider and diverse type of different physical and cognitive abilities of users).

Similar to other disclosed embodiments, the device (provided for on a crutch or other walking aid, e.g., a cane), the device can be a portable electronic device, powered by a battery, and includes electronic circuitry and can also include radar and/or an IMU (which preferably accelerometer and/or a gyroscope, and can also include the radar), as well as wireless communication with other device, and preferably, at least an associated exoskeleton.

Some embodiments may also include at least one of a radar and a camera (and in some embodiments, both), which is/are used to understand the surroundings of the exoskeleton. The radar (which can also be or include radar and/or LIDAR), which can be used and configured to map obstacles in a current path of the exoskeleton, estimate the current path (e.g., walking path), and based thereon, adjust the speed of the of the exoskeleton (and in some embodiments, dynamically adjust the speed thereof). Again, such functionality and corresponding structure (i.e., radar, camera, processor, circuitry, IMU) can be mounted on a crutch(es) and can be used by a user while walking as an indicator of a requested walking speed.

In some embodiments, the camera (at least one) may be used, either in place the identified components noted above (radar, LIDAR), or in addition thereto. In this respect, images can be collected (either still or video) and using artificial intelligence (AI) trained on images of different gestures, the AI can determine the perceptions and context of the gestures.

With respect to any of the disclosed inventions and embodiments, decision making using artificial intelligence can be used to determine context of any function based on data received from sensors such as a camera (e.g., a depth of field imager), one or more infra-red sensors, ultrasonic sensors, and radar and LIDAR sensors.

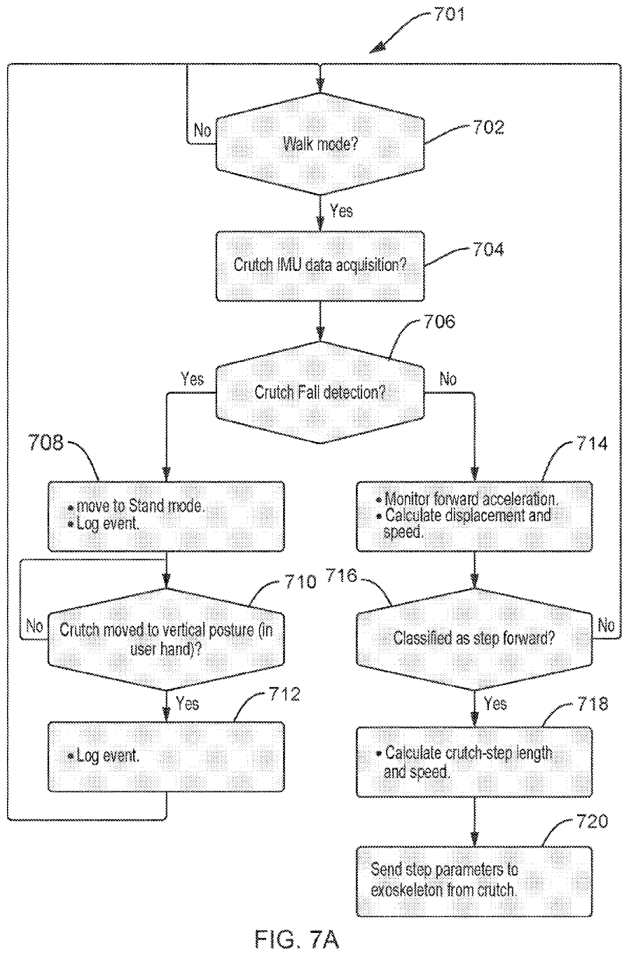

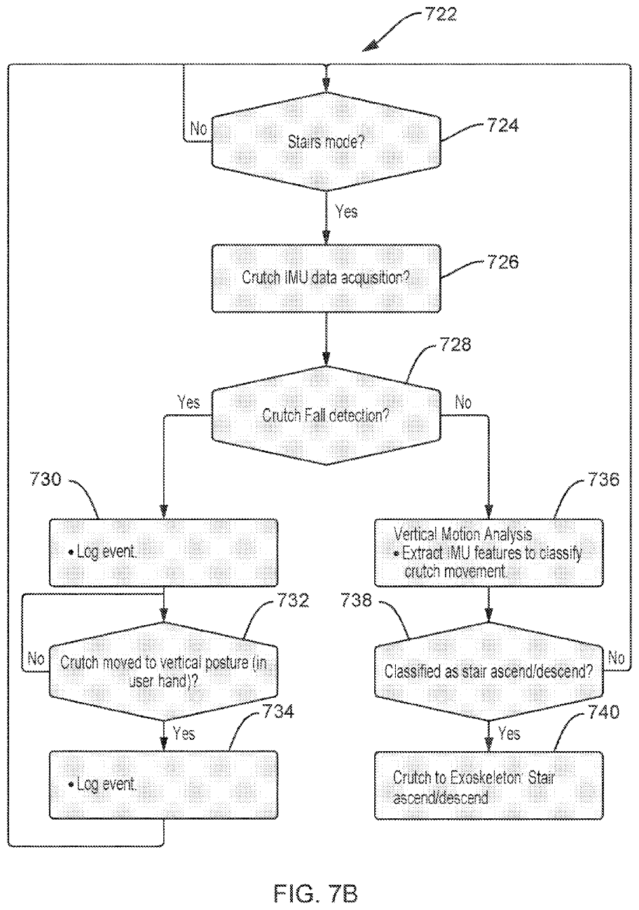

FIGS. 7A-B correspond to gesture recognition functionality according to some embodiments for the current disclosure. In FIG. 7A, gesture recognition/detection (both terms used interchangeably) process 701 to trigger a step forward via a crutch forward swing. The process/steps (of FIGS. 7A-B) can be conducted via at least one processor located on the exoskeleton, crutch or other device in communication with either or both of the exoskeleton or crutch. The at least one processor may be at least one of the CPU/controller, IMU, or other processor (here referred to generally as processor). Accordingly, in step 702, a determination is made whether the exoskeleton is in a walk mode or not; if not, the step repeated (in some embodiments, over and over so as to perform a monitoring function for the determination). If the exoskeleton is in a walk mode, at step 704, crutch data acquisition begins, in which at step 706, a determination is made whether a crutch (e.g., the distal end of the crutch) has been placed in contact with the ground (“Crutch Fall detection”). If so (“Yes”), at step 708, the exoskeleton proceeds to a standing mode, and the event is logged in memory (and/or at remote device/server), which follows by step 710 where a determination is made whether the crutch is moved to a vertical position (in the user's hand), if so, the event is logged in memory at step 712, and the process returns to steps 702.

Alternatively, if the Crutch Fall detection indicates that a/the crutch has not been placed in contact with the ground, in step 714, forward acceleration is monitored (via an accelerometer, see above) and displacement, e.g., movement of the exoskeleton and/or the crutch, and/or speed of the exoskeleton and/or the crutch, is calculated. At step 716, a determination is made whether at least one of (and preferably a plurality of, and in some embodiments, all of) acceleration, displacement and speed, can be classified as a step forward. If such is a step forward, at step 718, the processor calculates a/the crutch step length and/or speed (preferably both). From there, at step 720, step parameters are sent to the exoskeleton from the crutch to ascend/descend stairs (or from whatever device make the determination—e.g., a mobile phone or other remote device in communication with at least one of the exoskeleton and the crutch. This causes the exoskeleton to take a step. If the forward acceleration, speed, and/or displacement do not indicated/classify the same as indicating a step forward, the process returns to step 702.

FIG. 7B illustrates a flowchart 722 gesture recognition functionality as an indication to ascend or descend a stair(s). As indicated above, the process/steps can be conducted via at least one processor located on the exoskeleton, crutch or other device in communication with either or both of the exoskeleton or crutch. Accordingly, in step 724, a determination is made whether the exoskeleton is in a stair climbing mode, ascending or descending (“stair mode”) or not; if not, the step repeated (in some embodiments, over and over so as to perform a monitoring function for the determination). If the exoskeleton is in a stair mode, at step 726, crutch data acquisition begins in which motion data (via at least one of an accelerometer, a gyroscope, a camera provided on the crutch, and/or the exoskeleton or other device in communication with the crutch or exoskeleton) is collected, e.g., either by a processor provided on the crutch, a remote device (e.g., mobile phone), at which in step 728, a determination is made whether a crutch (or a part thereof, e.g., the distal end of the crutch) has been placed in contact with the ground (“Crutch Fall detection”). If so (“Yes”), at step 730, the event is logged in memory (memory may be on the crutch, the exoskeleton or other device in communication therewith), which it then follows at step 732 where a determination is made whether the crutch is moved to a vertical position (in the user's hand), if so, the event is logged in memory at step 734, and the process returns to steps 724, and if not, the determination is repeated (i.e., as a monitoring function for this determination).

Alternatively, if the Crutch Fall detection indicates that a/the crutch has not been placed in contact with the ground, in step 736, a vertical motion analysis is performed, where crutch movement parameters are extracted by the processor (e.g., one or more of speed, movement, distance, acceleration) to classify the crutch movement at step 738. If the crutch movement is classified as a stair climb (ascending or descending), at step 740, step parameters are sent to the exoskeleton from the crutch to ascend/descend stairs (or from whatever device makes the determination—e.g., a mobile phone or other remote device in communication with at least one of the exoskeleton and the crutch). This places the exoskeleton in stair mode. If the crutch parameters do not classify as a stair mode, the process returns to step 724.

One of skill in the art will appreciate that a crutch(es) can be used as a gesture control tool. For example, once user in a walk mode, walk cadence can be determined by a crutch(es) forward swing cadence, e.g., step length, step speed, pauses while walking. Similarly, once in stair mode, a crutch(es) gesture movement from ground level to stair level can be used as an indication for the user readiness to perform a stair (curb) action and provide information about the stair height. Accordingly, such functionality reduces the physical and/or mental strain on the user and can make human robotic interaction more intuitive (e.g., no need to preform stop maneuver with a crutch(es) to stop walking or pressing a specific button, just not swinging the crutch forward.

### Semi-Autonomous Step/Curb Ascend

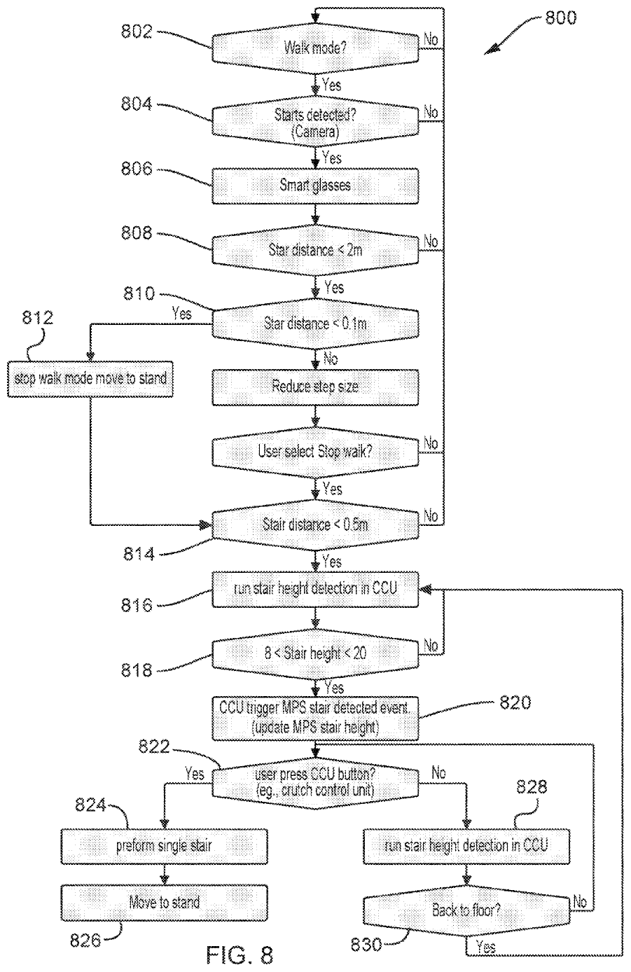

FIG. 8 is a flowchart illustrating a process 800 by which an exoskeleton can ascend a curb. Like the processes above in FIGS. 7A-B, such processes are operated by at least processor included with the exoskeleton, a crutch, and/or a remote device (e.g., a mobile phone), each in communication with one another (e.g., crutch in communication with the exoskeleton, and/or the mobile phone in communication with the skeleton and/or the crutch). The processor may be the CPU/controller, and/or the IMU (for example).

Accordingly, at step 802, the exoskeleton is monitored for being in walk mode. Once it is determined that the exoskeleton is in walk mode, it is then determined in step 804, in some embodiments via a camera, whether stairs are in the immediate area. If so, smart glasses worn by the user of the smart glasses can be used to estimate the distance to the stairs, and/or display the estimated distance to the user, step 806 and/or alert the user of the stairs (i.e., the smart eyeglasses performing as a heads-up display which may also be capable of selecting information, and/or changing modes of the exoskeleton via eye movement).

In step 808, if the stair distance is less than a first predetermined distance away, in some embodiments less than 10 meters, in some embodiments, less than 9 meters, in some embodiments less than 8 meters, in some embodiments, less than 7 meters, in some embodiments, less than 6 meters, in some embodiments, less than 5 meters, in some embodiments, less than 4 meters, in some embodiments, less than 3 meters, and in some embodiments, less than 2 meters, the process returns to step 802.

If the stair distance is less than the predetermined distance, at step 810, it is then determined if the steps are less than a second predetermined distance away, in some embodiments, less than 1 meter, in some embodiments, less than 0.9 meters, in some embodiments, less than 0.8 meters, in some embodiments, less than 0.7 meters, in some embodiments, less than 0.6 meters, in some embodiments, less than 0.5 meters, in some embodiments, less than 0.4 meters, in some embodiments, less than 0.3 meters, in some embodiments, less than 0.3 meters, in some embodiments, less than 0.2 meters, and in some embodiments, less than 0.1 meters, at step 812, walking mode is stopped and stand mode is activated.

At step 814, the stair distance is checked again, and if the stair distance it not less than a third predetermined distance, in some embodiments, less than 0.7 meters, in some embodiments, less than 0.6 meters, in some embodiments, less than 0.6 meters, in some embodiments, less than 0.5 meters, and in some embodiments, less than 0.4 meters, the process returns to step 802.

If the stair distance is less than the third predetermined distance, at step 816, a height of a stair(s) is determined via at least one of radar, lidar, and camera/image data (stair height sensor/system). Such technology for determination of a distance—including height, length, and/or width—is well known in the art. Thus, some embodiments utilize such known technology to create yet new embodiments for determining stair(s) height provides one aspect/functionality for semi-autonomous curb ascend. Collected data from the stair height sensor(s) can be processed by at least one processor (in some embodiments, the CPU, in some embodiments, the IMU, or other processor). The sensor(s), in some embodiments are located on the crutch, and in some embodiments, at least one of the exoskeleton and the crutch.

At step 818, if the stair(s) height is between two threshold values, in some embodiments, 8 and 20 cm (in some embodiments, between 6 and 30 cm, in some embodiments, between 7 and 25 cm, in some embodiments, between 9 and 15 cm, and in some embodiments, between 10 and 14 cm), at step 820, the sensor system triggers a stair detection event. At step 822, the user can press a button (via a user interface which may be a watch, smart glasses, one or more switches or buttons on the crutch(es) or a smart watch/wrist controller). If pressed, the exoskeleton enters a single stair step at step 824, then follows with step 826, enters a stand mode. If the button was not pressed, stair height detection is performed at step 828, and at step 830, it is determined if a leg element and/or a crutch(es) are back on a level surface (e.g., floor). If so, the process returns to step 816, if not, the process returns to step 822.

### EXAMPLE ACCORDING TO SOME EMBODIMENTS

The following examples are supported by the present disclosure, and support claims corresponding thereto, as well as supporting claims, according to some embodiments, with less limitations, as well as supporting claims with more limitations, and thus expressly supported by the subject disclosure:

Example 1: An exoskeleton user-interface comprising context awareness means for controlling one or more aspects of the use and control of the exoskeleton.

Example 2: The user-interface of example 1, wherein context awareness comprises one or more of surface type classification, stabilization and/or fall avoidance, perception, gait adaptation, and intent/gesture recognition.

Example 3: The user-interface of any of examples 1 or 2, wherein the context awareness comprises at least one of the following components: one or more sensors, an IMU, a processor, and communication means.

Example 4: The user-interface of any of examples 1-2, wherein the context awareness comprises at least a plurality of the following components: one or more sensors, an IMU, a processor, and communication means.

Example 5: The user-interface of any of examples 1-2, wherein the context awareness comprises at least a majority of the following components: one or more sensors, an IMU, a processor, and communication means.

Example 6: The user-interface of any of examples 1-2, wherein the context awareness comprises at least substantially all of the following components: one or more sensors, an IMU, a processor, and communication means.

Example 7: The user-interface of any of examples 1-2, wherein the context awareness comprises at least all of the following components: one or more sensors, an IMU, a processor, and communication means.

Example 8: The user-interface of any of examples 1-2, wherein the context awareness comprises any and all of the following components: one or more sensors, an IMU, a processor, and communication means.

Example 9: The user-interface of any of examples 1-8, wherein the user-interface is positioned on at least one crutch.

Example 10: The user-interface of any of examples 1-9, wherein at least one component is included on a first crutch and at least one component is included on a second crutch.

Example 11: The user-interface of any of examples 1-9, wherein at least two components are included on a first crutch and at least one component is included on a second crutch.

Example 12: The user-interface of any of examples 1-9, wherein at least two components are included on a first crutch and at least two components are included on a second crutch.

Example 13: The user-interface of any of example 1-12, wherein the user-interface comprises smart glasses for providing at least one of user interface function for controlling an exoskeleton and display of information with respect to the exoskeleton and/or surroundings of the exoskeleton at least during use, the smart glasses may comprise augmented reality eyewear, and wherein at least one of the exoskeleton, a crutch, and the eyewear include at least one camera collecting at least one of still and video.

Example 14: The user-interface of example 13, wherein the eyewear is configured to display exoskeleton modes and/or detection of objects imaged by the at least one camera and/or radar.

Example 15: The user-interface of example 14, wherein the at least one camera comprises a stereoscopic camera.

Example 16: The user-interface of any of examples 1-15, further comprising or in communication with an image and/or context detection engine, configured with machine learning so as to be configured for detection and classification of data collected including any and all of images, radar reflections, LED light reflection for objects and/or surfaces surrounding at least a portion of the area surrounding the exoskeleton.

Example 17: The user-interface of any of examples 1-16, further comprising radar and/or LIDAR, wherein the radar comprises a millimetric radar.

Example 18: The user-interface of any of examples 1-17, further comprising one or more additional sensors which include any and all of an ultrasonic sensor and an infrared sensor.

Example 19: The user-interface of any of examples 1-18, wherein the user interface comprises a crutch.

Example 20: A system, apparatus, device or method, associated with an exoskeleton, including detection means configured to detect an object at least within a path of the exoskeleton during use.

Example 21: The system, apparatus, device, or method of example 20, further comprising alert means configured to alert the user of the exoskeleton upon the object being within a direction of travel of the exoskeleton.

Example 22: The system, apparatus, device, or method of example 21, wherein the alert means comprises any and all of an audible alert including any and all of a tone and recorded or generated spoken alert, a visual alert which can comprise a light or an image displayed in view of the user of the exoskeleton.

Example 23: An exoskeleton apparatus comprising: an infrared (IR) spectrometry analysis system configured to detect a ground or floor surface that the exoskeleton is to or interacts with, including those corresponding to any and all of indoor areas: carpeting, ceramics, and tile, and outdoor areas: grass, dirt, concrete, brick, stone, and asphalt.

Example 24: The apparatus of example 23, further comprising at least one corresponding crutch device for use therewith.

Example 25: The apparatus of examples 23 or 24, wherein the IR system includes one or more and preferably, a plurality of light-emitting-diodes (LEDs) including at least one LED in the visible spectrum and at least one LED in the infrared spectrum.

Example 26: The apparatus of example 25, wherein the LEDs are configured to illuminate a surface upon which the exoskeleton is being used.

Example 27: The apparatus of any of examples 23-26, further comprising at least one photodiode arranged on a component/part of the exoskeleton, the at least one photodiode configured to measure at least one value of reflected LED from a surface.

Example 28: The apparatus of example 27, wherein the value measured is at least one wavelength.

Example 29: The apparatus of any of examples 27-28, wherein the measured values are processed via a processor so as to classify a surface being detected and/or encountered by the apparatus.

Example 30: The apparatus of example 29, wherein the processor compares the received signals with a lookup table of known values corresponding to a plurality of surfaces.

Example 31: The apparatus of example 29, wherein the processing by the processor utilizes artificial intelligence to determine the surface from the collected values.

Example 32: The apparatus of any of examples 23-31, wherein upon detection of a predetermined surface, the apparatus changes any and all of forces and movements so as to conform thereof to the characteristics of the surface.

Example 33: The apparatus of example 32, wherein each surface type corresponds to a specific set of forces and/or movements by the exoskeleton.

Example 34: The apparatus of any of examples 23-33, further comprising a battery-operated electronic device mounted on a portion of the at least one crutch.

Example 35: The apparatus of example 34, wherein the electronic device comprises electronic circuitry configured to preform spectrum analysis using signals collected from one or more photodiodes.

Example 36: The apparatus of any of examples 23-35, further comprising an internal mapping unit (IMU).

Example 37: The apparatus of example 36, wherein the IMU includes any and all of an accelerometer and a gyroscope.

Example 38: The apparatus of any of examples 36-37, wherein the IMU is configured to at least one of detect a walking pattern of the exoskeleton apparatus and/or any crutch encounters with a surface.

Example 39: The apparatus of any of examples 23-38, further comprising at least one camera.

Example 40: The apparatus of example 23 or 24, wherein the IR includes at least one camera.

Example 41: The apparatus of any of examples 39 or 40, wherein image information provided by the at least one camera is analyzed via artificial intelligence (AI) and/or digital signal processing algorithms, either locally or remotely to determine surface that the exoskeleton surface is or will soon encounter.

Example 42: The apparatus of example 41, wherein upon determination of the surface, the apparatus is configured to operate according to predetermined forces and/or movements so as to perform any and all of standing, walking, stairs, objects, and sitting, so as to operate on such identified surface.

Example 43: The apparatus of any of examples 23-42, wherein an/the IMU determines a crutch orientation.

Example 44: The apparatus of example 43, wherein the crutch orientation corresponds to a surface slope angle.

Example 45: The apparatus of any of examples 36-44, wherein the IMU includes at least one of an accelerometer and a gyroscope.

Example 46: The apparatus of example 45, wherein the accelerometer and/or gyroscope are configured to provide signals to a processor for the analysis of a walking pattern of the exoskeleton apparatus.

Example 47: The apparatus of any of examples 36-46, wherein based on output from the IMU, the exoskeleton is configured to adjust posture to accommodate a determined slope of a surface being encountered by the exoskeleton apparatus.

Example 48: The apparatus of any of examples 36-46, wherein based on output from the IMU, the exoskeleton is configured to adjust posture to accommodate a determined slope of a surface being encountered by the exoskeleton apparatus.

Example 49: The apparatus of any of examples 39-48, wherein the at least one camera configured to collect image data, and using AI and/or computer vision algorithms, determine the slope angle that the user of the exoskeleton is or will be encountering, and provide the slope angle to a controller of the exoskeleton to then select the correct posture and/or forces, movements, and speed; at least one, and preferably a plurality, and preferably all, for the exoskeleton to follow.

Example 50: A crutch for an exoskeleton configured to detect and determine a user's will so as to enter a mode of movement of an exoskeleton, including any and all of sit, stand, walk, stairs, and object avoidance based optionally on at least crutch movement (“gesture”) by a user of the crutch is recognized by the exoskeleton (“gesture recognition”) or user input via an interface of the crutch or exoskeleton.

Example 51: The crutch according to example 50, wherein upon the user of the exoskeleton approaching a stair or a curb, the user adjusts and/or moves the crutch in a predetermined manner such that the exoskeleton anticipates and will perform movement to climb up the stairs or curb.

Example 52: The crutch according to any of examples 50-51, wherein movement of the crutch forward indicates to the exoskeleton a length required for alignment with a/the stair/curb.

Example 53: The crutch according to any of examples 50-52, wherein upon a user swinging the crutch forward in walk mode controls walk cadence.

Example 54: The crutch according to example 53, wherein walk cadence comprises any and all of step length, step speed, step pause, and stop walking.

Example 55: The crutch according to any of examples 50-54, wherein a plurality of gestures can be used each corresponding to one or more unique movements and associated forces of motors and/or joints of the exoskeleton.

Example 56: A system, apparatus, device or method according to any of the above-claimed embodiments, or other embodiments disclosed herein, further comprising LIDAR.

Example 57: The system, apparatus, device or method according to any of the above-claimed embodiments, wherein information gathered by one or more sensors is analyzed via AI to determine one or more characteristics of the environment surrounding at least a portion of the exoskeleton.

Example 58: An exoskeleton-based method for detecting a type of surface upon which the exoskeleton is being used comprising:
using spectroscopy:
   emitting light from one or more LEDs arranged on at least one of one or more portions of an exoskeleton and one or more portions of a crutch, wherein the emitted light reflects of a surface proximate the exoskeleton;
   receiving the reflected light via one or more photodiodes arranged on at least one of one or more portions of the exoskeleton and one or more portions of the crutch;
   comparing one or more wavelengths of the reflected light to known wavelength values of one or more surface types stored in a memory or accessible via a network to identify the surface type; and/or
using imagery:
   collecting image data of the surface via at least one camera arranged on the exoskeleton, the crutch(es), or other accessory; and
   comparing the collected image data to image data one or more surface types stored in a memory or accessible via a network to identify the surface type.

Example 59: The method of example 58, wherein the surface comprises at least one of a ground surface and a vertical surface of a nearby structure.

Example 60: The method of examples 58 or 59, wherein the identified surface type is selected from the group consisting of carpeting, ceramics, tile, grass, dirt, concrete, brick, stone, asphalt, wet, snowy or icy and combinations of the foregoing.

Example 61: The method of any of examples 58-60, further comprising data collected form at least one of a crutch(es) and exoskeleton using pretrained AI models.

Example 62: The method of any of examples 58-61, wherein collecting and/or comparting is performed by one or more processors provided for on at least one of the exoskeleton, the crutch(es), and a remote device.

Example 63: The method of example 62, wherein the one or more processors comprise an internal mapping unit (IMU).

Example 64: The method of any of examples 58-63, wherein upon the surface being identified, the method further includes modifying the operation of the exoskeleton.

Example 65: The method of example 64, wherein the operation of the exoskeleton is modified by changing a mode of the exoskeleton.

Example 66: The method of example 65, wherein the mode is selected from the group considering of: walking, standing, sitting, collapsing, stopping, stair/curb climbing.

Example 67: The method of example 64, wherein modifying the operation of the exoskeleton comprises:
modifying the forces applied by one or more motors on one or more exoskeleton elements and/or components of such elements;
modifying a speed of movement of the exoskeleton and/or one or more components of the exoskeleton and/or components of such elements;
modifying a distance of movement of the exoskeleton and/or one or more components of the exoskeleton and/or components of such elements;
modifying relative angular movement between two elements of the exoskeleton and/or components of such elements;
modifying a timing of movement of the exoskeleton and/or movement of one or more components of the exoskeleton and/or components of such elements.

Example 68: The method of any of examples 58-67, further comprising collecting data from one or more sensors in additional to a spectrometry or image associated sensors.

Example 69: The method of example 68, wherein the one more additional sensors comprise at least one of an accelerometer and a gyroscope.

Example 70: The method of any of examples 58-69, wherein modifying operation of the exoskeleton corresponds to increasing the stability of the exoskeleton.

Example 71: An exoskeleton-based method for detecting an orientation of an exoskeleton relative to a ground surface, and/or an orientation of one or more accessories used with the exoskeleton comprising determining a slope of a surface upon which an exoskeleton is being used via one or more sensors, wherein the orientation of the exoskeleton and/or one or more accessories used with the exoskeleton corresponds to the angle determined by the one or more sensors.

Example 72: The method of example 71, wherein the one or more sensors comprise at least one of an accelerometer, a gyroscope and a level sensor.

Example 73: An exoskeleton-based method for determining an estimated slope of a ground surface upon which the exoskeleton is being used, the exoskeleton having a height and a central axis corresponding to the height and also including an associated crutch and crutch axis, the method comprising:
providing first data corresponding to a level crutch angle, the level crutch angle corresponding to the angle the crutch axis forms with the central axis upon the exoskeleton being in a standing or walking position on a flat, level surface; providing a database of a plurality of first crutch angels each corresponding to a slope of a ground surface;
determining a current crutch angle, the current crutch angle corresponding to the current angle the crutch axis forms with the central axis of the current position of the exoskeleton on a current ground surface upon which the exoskeleton is being used;
comparing the current crutch angle to the plurality of first crutch angles of the database to determine the estimated slope of the ground surface; and
determining the estimated ground slope of the current ground surface.

Example 74: An exoskeleton-based method for determining an estimated slope of a ground surface upon which the exoskeleton is being used, the exoskeleton having a height and a central axis corresponding to the height and also including an associated crutch and crutch axis, the method comprising:
determining a crutch angle for a plurality of times during operation of the exoskeleton in walking on a ground surface, each crutch angle corresponds to an angle the crutch axis forms with the central axis of a position of the exoskeleton on a ground surface for a specific time upon which the exoskeleton is being used;
determining an average crutch angle difference between the plurality of determined crutch angles;
upon the average crutch angle difference decreasing, the slope of the surface upon which the exoskeleton is being operated is ascending (going uphill); and
upon the average angle difference increasing, the slope of the surface upon which the exoskeleton is being operated is descending (going downhill).

Example 75: An exoskeleton-based method for determining an estimated slope of a ground surface upon which the exoskeleton is being used, the exoskeleton having a height and a central axis corresponding to the height and also including an associated crutch and crutch axis, the method comprising:
providing a level crutch angle, the level crutch angle corresponding to the angle the crutch axis forms with the central axis upon the exoskeleton being in a standing or walking position on a flat, level surface;
determining a current crutch angle for a plurality of times during operation of the exoskeleton in walking on a ground surface, each crutch angle corresponds to an angle the crutch axis forms with the central axis of a position of the exoskeleton on a ground surface for a specific time upon which the exoskeleton is being used;
determining an average crutch angle difference between the plurality of determined crutch angles; and
determining the slope of the ground surface by subtracting the level crutch angle from the average current crutch angle difference.

Example 76: The method of any of examples 73-75, further comprising adjusting the posture of the user via the exoskeleton based on the determined slope of the ground surface.

Example 77: The method of example 76, wherein adjusting the posture of the user via the exoskeleton comprises adjusting the angle between at least two elements of the exoskeleton.

Example 78: The method of example 76, wherein the at least two elements comprise each leg of the exoskeleton, components of each leg of the exoskeleton, and a back frame/housing.

Example 79: The method of any of examples 73-76, wherein crutch angles are determined by at least one of: image data taken by one or more cameras, one or more accelerometers, one or more gyroscopes, one or more level sensors, any one or more of the foregoing be mounted on at least one of the exoskeleton, a component of the exoskeleton, the crutch, and an accessory.

Example 80: The method of example 79, wherein the accessory comprises a chest worn housing, a smart watch, and a smart phone.

Example 81: The method of examples 79 or 80, wherein upon the use of a camera, images produced by the camera are compared to images of known slopes of ground surfaces.

Example 82: The method of examples 79 or 80, wherein upon the use of a camera, images produced by the camera are compared to images of known slopes of ground surfaces.

Example 83: The method of any of examples 73-82, upon the slope of the ground surface being determined, the method further comprises adjusting forces on elements of the exoskeleton, movements of one or more element and/or components thereof, speed of the exoskeleton, speed of one or more element and/or components thereof.

Example 84: An exoskeleton-based method for determining an estimated slope of a ground surface upon which the exoskeleton is being used comprising imaging, via one or more cameras provided on at least one of the exoskeleton, one or more components of the exoskeleton, a crutch, and an accessory, analyzing the images to determine one or more angles of any and/or all of the exoskeleton with the ground, the crutch with the ground, and the exoskeleton relative to the crutch.

Example 85: An exoskeleton-based method for operating an exoskeleton to step forward via gesture recognition, the method comprising:
(a) operating an exoskeleton including the use or more crutches;
(b) determining whether the exoskeleton is in walk mode,
(c) upon the exoskeleton being in walk mode, collecting crutch data, the crutch data including at least a position of the crutch;
(d) determining a crutch fall, wherein the crutch fall corresponds to the crutch coming in contact with the ground;
(e) upon the crutch fall being detected, the exoskeleton proceeds to standing mode and then determines whether the crutch is moved to a vertical position in a hand of the user of the exoskeleton, and repeating upon no crutch movement to a vertical position being determined, or, returning to step (a) upon crutch movement to a vertical position being determined;
(f) upon the crutch fall not occurring, monitoring at least one of a forward acceleration of at least one of the exoskeleton and/or crutch is monitored (via an accelerometer, see above), displacement or movement of the exoskeleton and/or the crutch;
(g) calculating a speed of at least one of the exoskeleton and the crutch;
(h) determining whether at least one of acceleration, displacement and speed corresponds to a step forward;
(i) upon a step forward determination, calculating a crutch step length and/or speed thereof, otherwise, returning to step (a);
(j) performing a step forward by the exoskeleton.

Example 86: An exoskeleton-based method for operating an exoskeleton to step forward via gesture recognition, the method comprising:
(a) operating an exoskeleton including the use or more crutches;
(b) determining whether the exoskeleton is in walk mode,
(c) upon the exoskeleton being in walk mode, collecting crutch data, the crutch data including at least a position of the crutch;
(d) determining a crutch fall, wherein the crutch fall corresponds to the crutch coming in contact with the ground;

Example 87: The method of example 86, further comprising:
(e) upon the crutch fall being detected, the exoskeleton proceeds to standing mode and then determines whether the crutch is moved to a vertical position in a hand of the user of the exoskeleton, and repeating upon no crutch movement to a vertical position being determined, or, returning to step (a) upon crutch movement to a vertical position being determined;

Example 88: The method of examples 86 or 87, further comprising:
(f) upon the crutch fall not occurring, monitoring at least one of a forward acceleration of at least one of the exoskeleton and/or crutch is monitored (via an accelerometer, see above), displacement or movement of the exoskeleton and/or the crutch.

Example 89: The method of any of examples 86-88, further comprising:
(g) calculating a speed of at least one of the exoskeleton and the crutch.

Example 90: The method of example 89, further comprising:
(h) determining whether at least one of acceleration, displacement and speed corresponds to a step forward.

Example 91: The method of any of examples 86-90, further comprising:
(i) upon a step forward determination, calculating a crutch step length and/or speed thereof, otherwise, returning to step (a).

Example 92: The method of any of examples 86-91, further comprising:
(j) performing a step forward by the exoskeleton.

Example 93: An exoskeleton-based method for operating an exoskeleton to ascend or descend one or more stairs via gesture recognition, the method comprising:
(a) operating an exoskeleton including the use or more crutches;
(b) determining whether the exoskeleton is in stair mode to ascend or descend a stair,
(c) upon the exoskeleton being in walk mode, collecting crutch data, the crutch data including at least a position of the crutch;
(d) determining a crutch fall, wherein the crutch fall corresponds to the crutch coming in contact with the ground;
(e) upon the crutch fall being detected, determining whether the crutch is moved to a vertical position in a hand of the user of the exoskeleton, and repeating upon no crutch movement to a vertical position being determined, or, returning to step (a) upon crutch movement to a vertical position being determined;
(f) upon the crutch fall not occurring, performing a vertical motion analysis of the crutch movement so as classify such movement as a stair climb; and
(g) upon classifying as a stair climb, performing, by the exoskeleton, a stair climb.

Example 94: The method of example 93, wherein a stair climb comprises ascending or descending one or more stairs.

Example 95: The method of examples 93 or 94, further comprising, after performing a stair climb, returning to step (a).

Example 96: The method of any of examples 93-95, wherein vertical motion analysis comprises at least one of a forward acceleration, displacement, and movement of the crutch.

Example 97: The method of any of examples 93-96, wherein vertical motion analysis comprises a speed of the crutch.

Example 98: An exoskeleton-based method for operating an exoskeleton using gesture recognition comprising:
(a) operating an exoskeleton including the use of one or more crutches,
(b) determining movement of at least one of the crutches via at least one or more sensors provided on at least one of: at least one crutch, the exoskeleton, and a mobile device being used with at least one of the exoskeleton and at least one of the crutches to determine whether the movement of the crutch is in a particular manner;
wherein determined movement of the crutch is in a particular manner, the exoskeleton is instructed to perform a specific function.

Example 99: The method of example 98, wherein the specific function comprises any and all of:
perform or change of mode of operation;
modifying the forces applied by one or more motors on one or more exoskeleton elements and/or components of such elements;
modifying a speed of movement of the exoskeleton and/or one or more components of the exoskeleton and/or components of such elements;
modifying a distance of movement of the exoskeleton and/or one or more components of the exoskeleton and/or components of such elements;
modifying relative angular movement between two elements of the exoskeleton and/or components of such elements; and
modifying a timing of movement of the exoskeleton and/or movement of one or more components of the exoskeleton and/or components of such elements.

Example 100: The method of examples 98 or 99, wherein the one or more sensors comprise at least one of: one or more cameras, an accelerometer, a gyroscope, an ultrasonic sensor, radar and LIDAR.

Example 101: An exoskeleton-based method for autonomous curb/stair ascend in operating an exoskeleton, the method comprising:
(a) determining whether an exoskeleton is in a walk mode;
(b) upon being in a walk mode, determining whether one or more steps/stairs are in an immediate area where the exoskeleton is being operated;
(c) optionally alerting the user of the exoskeleton that a step has been determined to be in the immediate area;
(d) estimating a distance to the step and/or display an/the estimated distance to the user;
(e) upon the estimated distance not being less than a first predetermined distance, the method returns to step (a);
(f) upon the estimated distance being less than first predetermined distance, determining if the step is less than a second predetermined distance away;
(g) upon the step not being less than a second predetermined distance away, reducing the steps size of the exoskeleton;
(h) determining whether the user has caused the operation of the exoskeleton to stop walking, if the user has not caused the operation of the exoskeleton to stop walking, the method returns to step (a);
(i) upon the user causing the operation of the exoskeleton to stop walking, determining whether the step distance is less than a third predetermined distance, wherein if the step is not within the third predetermined distance, the method returns to step (a);
(j) upon the step distance being within the third predetermined distance, determining a height of the step;
(k) if the step height is within a predetermined range, a step detection event is triggered; and
(l) upon the user causing the exoskeleton to perform climb up the step, which may comprise selecting an icon, pressing a button, or via verbal or glancing look via smart-glasses, perform at least one step climb and transition to stand mode.

Example 102: The method of example 101, further comprising repeating step height determination unless the exoskeleton has returned to a floor position at which point the method returns to step (1).

### General Considerations

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described or illustrated herein. More generally, those skilled in the art will readily appreciate that all structure, parameters, dimensions, materials, functionality, and configurations described herein are meant to be an example and that the actual structure, parameters, dimensions, materials, functionality, and configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the claims supported by the present disclosure, and equivalents thereto, inventive embodiments may be practiced otherwise than as specifically described and claimed. Inventive embodiments of the present disclosure are also directed to each individual feature, system, article, structure, material, kit, functionality, step, and method described herein. In addition, any combination of two or more such features, systems, articles, structure, materials, kits, functionalities, steps, and methods, if such are not mutually inconsistent, is included within the inventive scope of the present disclosure. Some embodiments may be distinguishable from the prior art for specifically lacking one or more features/elements/functionality (i.e., claims directed to such embodiments may include negative limitations).

Also, as noted, various inventive concepts may be embodied as one or more methods. The acts performed as part of a method may be ordered in any suitable way. Accordingly, embodiments may be constructed in which acts are performed in an order different than illustrated, which may include performing some acts simultaneously, even though shown as sequential acts in illustrative embodiments. Moreover, while some embodiments are disclosed with an express number of steps, some embodiments related to such methods may also comprise only one or two, or several of such steps, which yield yet further embodiments of the present disclosure.

Any and all references to publications or other documents, including but not limited to, patents, patent applications, articles, webpages, books, etc., presented anywhere in the present application, are herein incorporated by reference in their entirety. Moreover, all definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The terms “can” and “may” are used interchangeably in the present disclosure, and indicate that the referred to element, component, structure, function, functionality, objective, advantage, operation, step, process, apparatus, system, device, result, or clarification, has the ability to be used, included, or produced, or otherwise stand for the proposition indicated in the statement for which the term is used (or referred to) for a particular embodiments). Additionally, “any and all” of certain recited items including a part(s), a structure(s), a function(s)/functionality, a clarification(s) or a step(s) (and the like) corresponds to certain embodiments only including one of such item (and in some embodiments, only such item), certain embodiments including two or more of such items (and in some embodiments, only two or more of such items), certain embodiments including substantially all of the items (and in some embodiments, only substantial number of the items), and certain embodiments including all of such items (and in some embodiment, only all of such embodiments).

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined.

Other elements may optionally be present other than the elements specifically identified by the “and/or” clause, whether related or unrelated to those elements specifically identified. Thus, as a non-limiting example, a reference to “A and/or B”, when used in conjunction with open ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of’ or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

“Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of’ and “consisting essentially of’ shall be closed or semi-closed transitional phrases, respectively, as set forth in the United States Patent Office Manual of Patent Examining Procedures, Section 2111.03.

1. An exoskeleton-based method for determining an estimated slope of a ground surface upon which the exoskeleton is being used, the exoskeleton having a height and a central axis corresponding to the height and also including an associated crutch and crutch axis, the method comprising:
providing first data corresponding to a level crutch angle, the level crutch angle corresponding to the angle the crutch axis forms with the central axis upon the exoskeleton being in a standing or walking position on a flat, level surface;
providing a database of a plurality of first crutch angles each corresponding to a slope of a ground surface;
determining a current crutch angle, the current crutch angle corresponding to the current angle the crutch axis forms with the central axis of the current position of the exoskeleton on a current ground surface upon which the exoskeleton is being used;
comparing the current crutch angle to the plurality of first crutch angles of the database to determine the estimated slope of the ground surface; and
determining the estimated ground slope of the current ground surface.

2. An exoskeleton-based method for determining an estimated slope of a ground surface upon which the exoskeleton is being used, the exoskeleton having a height and a central axis corresponding to the height and also including an associated crutch and crutch axis, the method comprising:
determining a crutch angle for a plurality of times during operation of the exoskeleton in walking on a ground surface, each crutch angle corresponds to an angle the crutch axis forms with the central axis of a position of the exoskeleton on a ground surface for a specific time upon which the exoskeleton is being used;
determining an average crutch angle difference between the plurality of determined crutch angles;
upon the average crutch angle difference decreasing, the slope of the surface upon which the exoskeleton is being operated is ascending (going uphill); and
upon the average angle difference increasing, the slope of the surface upon which the exoskeleton is being operated is descending (going downhill).

3. An exoskeleton-based method for determining an estimated slope of a ground surface upon which the exoskeleton is being used, the exoskeleton having a height and a central axis corresponding to the height and also including an associated crutch and crutch axis, the method comprising:
providing a level crutch angle, the level crutch angle corresponding to the angle the crutch axis forms with the central axis upon the exoskeleton being in a standing or walking position on a flat, level surface;
determining a current crutch angle for a plurality of times during operation of the exoskeleton in walking on a ground surface, each crutch angle corresponds to an angle the crutch axis forms with the central axis of a position of the exoskeleton on a ground surface for a specific time upon which the exoskeleton is being used;
determining an average crutch angle difference between the plurality of determined crutch angles; and
determining the slope of the ground surface by subtracting the level crutch angle from the average current crutch angle difference.

4. The method of claim 3, further comprising adjusting the posture of the user via the exoskeleton based on the determined slope of the ground surface.

5. The method of claim 4, wherein adjusting the posture of the user via the exoskeleton comprises adjusting the angle between at least two elements of the exoskeleton.

6. The method of claim 5, wherein the at least two elements comprise each leg of the exoskeleton, components of each leg of the exoskeleton, and a back frame/housing.

7. The method of claim 3, wherein crutch angles are determined by at least one of: image data taken by one or more cameras, one or more accelerometers, one or more gyroscopes, one or more level sensors, any one or more of the foregoing being mounted on at least one of the exoskeleton, a component of the exoskeleton, the crutch, and an accessory.

8. The method of claim 7, wherein the accessory comprises a chest worn housing, a smart watch, and a smart phone.

9. The method of claim 7, wherein upon the use of a camera, images produced by the camera are compared to images of known slopes of ground surfaces.

10. The method of claim 3, upon the slope of the ground surface being determined, the method further comprises adjusting forces on elements of the exoskeleton, movements of one or more elements and/or components thereof, speed of the exoskeleton, speed of one or more elements and/or components thereof.
